(19) United States
(12) Patent Application Publication
(10) Pub. No.: US 2020/0371635 A1
(43) Pub. Date: Nov. 26, 2020

(54) SHIFT DEVICES AND METHODS FOR SHIFTING

(71) Applicant: MARQUARDT GMBH, Rietheim-Weilheim (DE)

(72) Inventors: Caleb Burgess, Saline, MI (US); Branden Jarbo, Macomb, MI (US); Ryan Ward, Grand Blanc, MI (US)

(73) Assignee: MARQUARDT GMBH, Rietheim-Weilheim (DE)

(21) Appl. No.: 16/880,159

(22) Filed: May 21, 2020

Related U.S. Application Data
(60) Provisional application No. 62/851,249, filed on May 22, 2019.

(51) Int. Cl. G06F 3/041; B60K 20/02; F16H 59/12

(52) U.S. Cl. CPC G06F 3/0416; F16H 59/12; B60K 20/02

(57) ABSTRACT

A shift device, comprising first and second series of touch sensors and an operating mode element. The first and second series of touch sensors are arranged in first and second patterns, respectively, that each extends in a first direction. The first and second series are aligned to provide a series of touch sensor pairs, for each of which the touch sensors are aligned in a second direction, the second direction substantially perpendicular to the first direction. Each touch sensor pair corresponds to a respective one of a plurality of operating modes. The operating mode element is configured to change from one operating modes to another, and to emit a shift signal, only upon occurrence of a sequence of actions consisting of a shift initiation action and one or more operating mode change action. Also, methods of shifting.

### CROSS-REFERENCE TO RELATED APPLICATIONS

This application claims the benefit under 35 U.S.C. 119 section (e) of U.S. Provisional Patent Application No. 62/851,249, filed May 22, 2019, the entirety of which is incorporated herein by reference.

### FIELD OF THE INVENTIVE SUBJECT MATTER

The present inventive subject matter relates to a shift device. In some aspects, the present inventive subject matter relates to a shift device that comprises touch sensors and an operating mode element, in which the operating mode element changes from one operating mode to a different operating mode, and emits a shift signal, only upon the touch sensors sensing touches in certain sequences. The present inventive subject matter also relates to methods of shifting in which shifting occurs only upon touch sensors sensing touches in certain sequences.

### BACKGROUND

There are many different shift devices in existence, but there is an ongoing need for shift devices that are easier to operate and/or that integrate more easily into equipment such as automobiles and other vehicles (personal watercrafts, motorboats, motorcycles, heavy equipment, snowmobiles, etc.).

### BRIEF SUMMARY OF THE INVENTIVE SUBJECT MATTER

In some aspects of the present inventive subject matter, there is provided a shift device (i.e., a device for issuing shift commands upon receiving valid shift sequences) that comprises an operating mode element that is configured to shift among a plurality of operating modes, and to emit a shift signal upon shifting from one of the plurality of operating modes to another of the plurality of operating modes, the shift signal indicating the operating mode to which the operating mode element has shifted.

A representative embodiment of a shift device in accordance with the present inventive subject matter is a shift device for a motor vehicle, in which the operating mode element is configured to shift among five operating modes (a park operating mode, a reverse operating mode, a neutral operating mode, a drive operating mode and a low operating mode), and, upon shifting, to send a shift signal indicating the operating mode to which the operating mode element has shifted, such shift signals causing the motor vehicle to shift among five transmission modes (a park transmission mode, a reverse transmission mode, a neutral transmission mode, a drive transmission mode and a low transmission mode).

In this representative embodiment, each of the five operating modes of the operating mode element corresponds to a respective one of the five transmission modes of the motor vehicle, i.e., the park operating mode of the operating mode element corresponds to the park transmission mode of the vehicle, the reverse operating mode of the operating mode element corresponds to the reverse transmission mode of the vehicle, etc.

In this representative embodiment, the shift device comprises a first series of touch sensors and a second series of touch sensors. The first series of touch sensors consists of five touch sensors arranged in a pattern that extends in a first direction, and the second series of touch sensors likewise consists of five touch sensors also arranged in a pattern that extends in the first direction, i.e., substantially parallel to the first series of touch sensors. The first pattern and the second pattern are aligned to provide a series of five touch sensor pairs. For each of the touch sensor pairs, the touch sensor of the first series and the touch sensor of the second series are aligned in a second direction, i.e., perpendicular to the first direction.

In this representative embodiment, each of the five touch sensor pairs corresponds to a respective one of the five respective operating modes of the motor vehicle (i.e., the first touch sensor pair corresponds to the “park” operating mode; the second touch sensor pair corresponds to the “reverse” operating mode, etc.).

In this representative embodiment, signals from the touch sensors are supplied to the operating mode element, and the operating mode element changes from one operating mode to another and sends at least one shift signal to the transmission of the motor vehicle (to cause the transmission of the motor vehicle to change to the transmission mode that corresponds to the operating mode to which the operating mode element has shifted) upon the occurrence of a valid shift sequence, the criteria for whether a sequence of actions is a valid shift sequence being detailed herein.

In accordance with a first aspect of the present inventive subject matter, there is provided a shift device, comprising:

at least first and second series of touch sensors; and

an operating mode element,

the first series comprising at least three touch sensors, the touch sensors in the first series arranged in a first pattern that extends in a first direction,

the second series comprising at least three touch sensors, the touch sensors in the second series arranged in a second pattern that extends in the first direction, the second pattern extending substantially parallel to the first pattern,

the first pattern and the second pattern aligned to provide a plurality of touch sensor pairs,

each touch sensor pair comprising a touch sensor of the first series and a touch sensor of the second series,

for each touch sensor pair, the touch sensor of the first series and the touch sensor of the second series are aligned in a second direction, the second direction substantially perpendicular to the first direction,

each touch sensor pair corresponding to a respective one of a plurality of operating modes, and

the operating mode element configured to change from one of the plurality of operating modes to a different one of the plurality of operating modes, and to emit a shift signal indicating the operating mode to which the operating mode element has changed, only upon occurrence of a sequence of actions consisting of:
a shift initiation action consisting of each touch sensor in a shift initiation touch sensor pair simultaneously sensing a touch, said shift initiation touch sensor pair being one of said plurality of touch sensor pairs and corresponding to a current operating mode, said current operating mode being one of said operating modes and being an operating mode in which the operating mode element is at the time of the shift initiation action, and then
at least a first operating mode change action, each said operating mode change action consisting of:
   each touch sensor in a shift-to sensor pair simultaneously sensing a
   touch within a maximum duration time interval since said shift initiation action or a most recent previous operating mode change action,
   said shift-to sensor pair being one of said plurality of touch sensor pairs and being adjacent (as defined below) to a current mode touch sensor pair,
   said current mode touch sensor pair being one of said plurality of touch sensor pairs and corresponding to an operating mode in which the operating mode element is at the time of the operating mode change action.

In accordance with a second aspect of the present inventive subject matter, there is provided a shift device, comprising:

first and second series of touch sensors;

an operating mode element; and

a sensor housing,

the first series comprising at least a first series first touch sensor, a first series second touch sensor, a first series third touch sensor and a first series fourth touch sensor, the touch sensors in the first series arranged in a first pattern that extends in a first direction,

the second series comprising at least a second series first touch sensor, a second series second touch sensor, a second series third touch sensor and a second series fourth touch sensor, the touch sensors in the second series arranged in a second pattern that extends in the first direction, the second pattern extending substantially parallel to the first pattern,

the first pattern and the second pattern aligned to provide a plurality of touch sensor pairs,

each touch sensor pair comprising a touch sensor of the first series and a touch sensor of the second series,

the plurality of touch sensor pairs comprises at least a first touch sensor pair, a second touch sensor pair that is adjacent to the first touch sensor pair, a third touch sensor pair that is adjacent to the second touch sensor pair, and a fourth touch sensor pair that is adjacent to the third touch sensor pair,

the first touch sensor pair comprises the first series first touch sensor and the second series first touch sensor,

the second touch sensor pair comprises the first series second touch sensor and the second series second touch sensor,

the third touch sensor pair comprises the first series third touch sensor and the second series third touch sensor,

the first touch sensor pair comprises the first series fourth touch sensor and the second series fourth touch sensor,

for each touch sensor pair, the touch sensor of the first series and the touch sensor of the second series are aligned in a second direction, the second direction substantially perpendicular to the first direction,

each touch sensor pair corresponding to a respective one of a plurality of operating modes of a motor vehicle, said operating modes comprising a park mode, a reverse mode, a neutral mode and a drive mode,

the first touch sensor pair corresponding to said park mode,

the second touch sensor pair corresponding to said reverse mode,

the third touch sensor pair corresponding to said neutral mode, and

the fourth touch sensor pair corresponding to said drive mode,

the operating mode element configured to change from one of the plurality of operating modes to a different one of the plurality of operating modes, and to emit a shift signal indicating the operating mode to which the operating mode element has changed, only upon occurrence of a sequence of actions consisting of:
a shift initiation action consisting of each touch sensor in a shift initiation touch sensor pair simultaneously sensing a touch, said shift initiation touch sensor pair being one of said plurality of touch sensor pairs and corresponding to a current operating mode, said current operating mode being one of said operating modes and being an operating mode in which the operating mode element is at the time of the shift initiation action, and then
at least a first operating mode change action, each said operating mode change action consisting of:
   each touch sensor in a shift-to sensor pair simultaneously sensing a touch within a maximum duration time interval since said shift initiation action or a most recent previous operating mode change action,
   said shift-to sensor pair being one of said plurality of touch sensor pairs and being adjacent to a current mode touch sensor pair,
   said current mode touch sensor pair being one of said plurality of touch sensor pairs and corresponding to an operating mode in which the operating mode element is at the time of the operating mode change action,

the sensor housing comprising at least a first recessed region and a second recessed region,

each of the touch sensors comprising a respective touch sensor contact,

the touch sensor contacts of the first series of touch sensors and the first recessed region together defining a first recess, and

the touch sensor contacts of the second series of touch sensors and the second recessed region together defining a second recess.

In accordance with a third aspect of the present inventive subject matter, there is provided a shift device, comprising:

at least first and second series of touch sensors; and

a shift command signal emitter,

the first series comprising at least three touch sensors, the touch sensors in the first series arranged in a first pattern that extends in a first direction,

the second series comprising at least three touch sensors, the touch sensors in the second series arranged in a second pattern that extends in the first direction, the second pattern extending substantially parallel to the first pattern,

the first pattern and the second pattern aligned to provide a plurality of touch sensor pairs,

each touch sensor pair comprising a touch sensor of the first series and a touch sensor of the second series,

for each touch sensor pair, the touch sensor of the first series and the touch sensor of the second series are aligned in a second direction, the second direction substantially perpendicular to the first direction,

each touch sensor pair corresponding to a respective one of a plurality of operating modes, and

the operating mode element configured to change from one of the plurality of operating modes to a different one of the plurality of operating modes, and to emit a shift signal indicating the operating mode to which the operating mode element has changed, only upon occurrence of a sequence of actions consisting of:
a shift initiation action consisting of each touch sensor in a shift initiation touch sensor pair simultaneously sensing a touch, said shift initiation touch sensor pair being one of said plurality of touch sensor pairs and corresponding to a current operating mode, said current operating mode being one of said operating modes and being an operating mode in which the operating mode element is at the time of the shift initiation action, and then
at least a first operating mode change action, each said operating mode change action consisting of:
   each touch sensor in a shift-to sensor pair simultaneously sensing a touch within a maximum duration time interval since said shift initiation action or a most recent previous operating mode change action,
   said shift-to sensor pair being one of said plurality of touch sensor pairs and being different from a current mode touch sensor pair,
   said current mode touch sensor pair being one of said plurality of touch sensor pairs and corresponding to an operating mode in which the operating mode element is at the time of the operating mode change action.

In accordance with a fourth aspect of the present inventive subject matter, there is provided a method of shifting, comprising:
performing a shift initiation action comprising simultaneously touching both touch sensors in a first touch sensor pair corresponding to a first operating mode, the first touch sensor pair being among a plurality of touch sensor pairs in a device for issuing shift commands upon receiving valid shift sequences, said first operating mode being selected from among a plurality of operating modes, said current operating mode being an operating mode in which equipment is currently operating,
and then, within a maximum duration time interval since said simultaneously touching both touch sensors in the first touch sensor pair, performing a first operating mode change action, said first operating mode change action comprising simultaneously touching both touch sensors in a second touch sensor pair corresponding to a second operating mode, the second touch sensor pair being among the plurality of touch sensor pairs, the second operating mode being among the plurality of operating modes,
each of said plurality of touch sensor pairs comprising one of a first series of touch sensors and one of a second series of touch sensors, the first series comprising at least three touch sensors arranged in a first pattern that extends in a first direction, the second series comprising at least three touch sensors arranged in a second pattern that extends in the first direction, the second pattern extending substantially parallel to the first pattern,
the first pattern and the second pattern aligned to provide said plurality of touch sensor pairs,
each touch sensor pair comprising a touch sensor of the first series and a touch sensor of the second series,
for each touch sensor pair, the touch sensor of the first series and the touch sensor of the second series are aligned in a second direction, the second direction substantially perpendicular to the first direction,
each touch sensor pair corresponding to a respective one of said plurality of operating modes.

The inventive subject matter may be more fully understood with reference to the accompanying drawings and the following detailed description of the inventive subject matter.

### BRIEF DESCRIPTION OF THE DRAWING FIGURES

FIG. 1 is a front view of a first embodiment of a shift device 10 (i.e., a device for issuing shift signals upon receiving a valid shift initiation action and at least one valid operating mode change action) in accordance with some aspects of the present inventive subject matter.

FIG. 2 is a perspective view of the shift device 10.

FIG. 3 is another perspective view of the shift device 10.

FIG. 4 is an enlarged view of a portion of the perspective view of FIG. 3.

FIG. 5 is a front view of the shift device 10 with an operator touching the touch sensors corresponding to a “Park” operating mode.

FIG. 6 is a view of the shift device 10 mounted in an instrument panel 12 of a motor vehicle.

FIG. 7 is a perspective view of a second embodiment of a shift device 70 in accordance with some aspects of the present inventive subject matter.

FIG. 8 is a front view of a third embodiment of a shift device 80 in accordance with some aspects of the present inventive subject matter.

FIG. 9 is a front view of a fourth embodiment of a shift device 200 in accordance with some aspects of the present inventive subject matter.

FIG. 10 shows the views of the shift device 10 depicted in FIGS. 1-4 without reference numbers.

FIG. 11 shows the view of the shift device 10 depicted in FIG. 5 without reference numbers.

### DETAILED DESCRIPTION OF THE INVENTIVE SUBJECT MATTER

The present inventive subject matter encompasses many combinations of elements and features. The expression “In some embodiments in accordance with the present inventive subject matter, which can include or not include, as suitable, any of the other features described herein,” or the like, is used in the present specification to introduce elements and/or features of the present inventive subject matter that can be included or not included in any particular embodiment, i.e., elements and/or features that can be combined in any suitable way. In other words, the present inventive subject matter encompasses all combinations of elements and/or features that are introduced with the expression “In some embodiments in accordance with the present inventive subject matter, which can include or not include, as suitable, any of the other features described herein,” or the like.

The expression “aligned,” as used herein, means that there is at least one straight line that would pass through each of the items that are characterized as being aligned.

The expression “direction,” as used herein (e.g., in the expression “first direction” and the expression “second direction”), means anything that extends along a portion of a ray, or along a portion of any ray that is parallel thereto (i.e., line segments that are parallel to each other extend in the same direction). A statement that a series of items are arranged in a first pattern, and the first pattern extends in a first direction, means that there is at least one straight line that passes through each of the items in the first pattern and that extends in the first direction.

The expression “substantially parallel,” as used herein, means that two lines (or two planes) that are characterized as being “substantially parallel” do not diverge from each other by more than 5 degrees.

The expression “substantially perpendicular,” as used herein, means that at least 90% of the points in the structure which is characterized as being substantially perpendicular to a reference plane or line are located on one of or between a pair of planes (1) which are perpendicular to the reference plane, (2) which are parallel to each other and (3) which are spaced from each other by a distance of not more than 5% of the largest dimension of the structure.

The expression “substantially planar,” as used herein, means that at least 90% of the points in the surface which is characterized as being substantially flat are located on one of or between a pair of planes which are parallel and which are spaced from each other by a distance of not more than 5% of the largest dimension of the surface.

A statement that two sensors “sense a touch” (or the like) means that each senses a touch (e.g., a user touches one of the sensors with one finger and the user touches the other with another finger or a thumb).

The expression “simultaneous,” as used herein (e.g., in the expression “touch sensor pair simultaneously sensing a touch”), means that there is at least some time where both events are occurring (e.g., both sensors in the touch sensor pair are being touched). Accordingly, two touch sensors can be touched simultaneously even though the onset of one of the sensors being touched starts before the onset of the other being touched, and even though the time during which one of the sensors is being touched ends before the time that the other of the sensors is being touched. For example, if a first sensor is touched at a particular reference time and released at 0.5 seconds after the reference time, and a second sensor is touched at 0.3 seconds after the reference time and released at 0.8 seconds after the reference time, the touch sensors were simultaneously touched (even though the simultaneous touching lasted only 0.2 seconds).

An “axis” of a structure (e.g., an “axis” of a recess), as used herein, refers to a line that extends along the structure for a distance that is equal to at least 90% of the longest dimension of the structure.

The expression “contour,” as used herein, in connection with the contour of a structure, means the shape defined by an intersection of the structure with an imaginary plane oriented in a specific direction (i.e., perpendicular to a particular direction).

The expression “surface irregularity,” as used herein, means any irregularity that is easily detected by running one's hand along a surface, e.g., a raised portion or a recessed portion (such as a dimple, a bump, a ridge, a groove, or combinations thereof).

The expression “substantially along an entire distance” (e.g., “the protruding region extends at least substantially along the entire distance of . . . ”) means at least 90% of the distance referred to, i.e., a continuous section that is at least 90% as long as the distance referred to, or two or more sections, that add up to at least 905 as long as the distance referred to.

As noted above, in some aspects, the present inventive subject matter relates to a shift device that comprises at least first and second series of touch sensors, and an operating mode element.

Persons of skill in the art are familiar with a variety of touch sensors (e.g., Arduino touch sensors), and any suitable touch sensors can be employed in shift devices according to the present inventive subject matter. For example, persons of skill in the art are familiar with capacitance switches (i.e., devices in which capacitance increases and triggers a switch upon a person touching a contact), resistance touch switches, and piezoelectric touch switches, and any such touch sensors (including combinations thereof), can be employed as any of the touch sensors in devices according to the present inventive subject matter (and the present inventive subject matter encompasses shift devices that comprise any of such devices).

In some embodiments according to the present inventive subject matter, which can include or not include, as suitable, any of the other features described herein, other sensors can be used in place of or in addition to any of the touch sensors, e.g., an optical sensor (for example, a device that has one or more light emitter and one or more light detector oriented such that light emitted from the light emitter (or from one or more of the light emitters) is received by the light receiver (or one or more of the light receivers) unless something is blocking the light) can be used to detect an operator's finger in a particular location or region.

The touch sensors in a particular shift device can all be of the same type of touch sensor, or a shift device can comprise any respective quantity of each of one or more types of touch sensors.

As noted above, the operating mode element is configured to change from one of the plurality of operating modes to a different one of the plurality of operating modes, and to emit a shift signal indicating the operating mode to which the operating mode element has changed, only upon occurrence of a sequence of actions consisting of a shift initiation action (as defined herein), and then at least a first operating mode change action (as defined herein).

The expression “operating mode,” as used herein, does not mean that the operating mode element operates differently in the various operating mode; instead, it means that the operating mode element stores information as to the “operating mode” in which it currently is, and sends signals to equipment (e.g., a vehicle transmission) regarding the operating mode to which it has changed (upon a shift initiation action and at least a first operating mode change action).

Persons of skill in the art are familiar with a variety of devices (i.e., components or combinations of components) that can (1) receive sequences of signals from touch sensors and detect whether those signals satisfy a particular criterion (or any of a group of criteria), and that (2) upon detecting a sequence of signals that satisfy such criterion (or group of criteria), change to a different operating mode and emit a signal indicating the operating mode to which it has changed. For example, persons of skill in the art can readily make a computer chip (or two or more computer chips working together) that (1) receives sequences of signals from touch sensors and detect whether those signals satisfy a particular criterion (or any of a group of criteria), and that (2) upon detecting a sequence of signals that satisfy such criterion (or group of criteria), changes to a different operating mode and emit a signal indicating the operating mode to which it has changed. Any such devices can be used in the shift devices according to the present inventive subject matter, and the present inventive subject matter encompasses shift devices that comprise any of such devices.

In some embodiments according to the present inventive subject matter, which can include or not include, as suitable, any of the other features described herein, there is provided a shift device that comprises a first series of touch sensors arranged in a first pattern that extends in a first direction, and a second series of touch sensors arranged in a second pattern that extends in the first direction, the second pattern extending substantially parallel to the first pattern, the first pattern and the second pattern aligned to provide a plurality of touch sensor pairs, each touch sensor pair comprising a touch sensor of the first series and a touch sensor of the second series, for each touch sensor pair, the touch sensor of the first series and the touch sensor of the second series are aligned in a second direction, the second direction substantially perpendicular to the first direction, each touch sensor pair corresponding to a respective one of a plurality of operating modes. In some of such embodiments, one or more of the following features is satisfied:
a first line is substantially co-linear with respective a first edge of each of the touch sensors in the first series;
a second line is substantially co-linear with a respective second edge of each of the touch sensors in the first series;
a third line is substantially co-linear with a respective first edge of each of the touch sensors;
a fourth line is substantially co-linear with a respective second edge of each of the touch sensors; and/or
for each of the touch sensor pairs, one line is substantially co-linear with a respective third edge of both of the touch sensor, and another line is substantially co-linear with a respective second edge of both of the touch sensors.

As noted above, In some embodiments according to the present inventive subject matter, which can include or not include, as suitable, any of the other features described herein, a shift initiation action consists of each touch sensor in a shift initiation touch sensor pair simultaneously sensing a touch (e.g., an operator simultaneously touching such touch sensor pair), the shift initiation touch sensor pair being one of the plurality of touch sensor pairs and corresponding to a current operating mode, the current operating mode being one of said operating modes and being an operating mode in which the operating mode element is at the time of the shift initiation action.

As also noted above, In some embodiments according to the present inventive subject matter, which can include or not include, as suitable, any of the other features described herein, an operating mode change action consists of:
each touch sensor in a shift-to sensor pair simultaneously sensing a touch within a maximum duration time interval since the shift initiation action or a most recent previous operating mode change action,
said shift-to sensor pair being one of said plurality of touch sensor pairs and being different from a current mode touch sensor pair,
the current mode touch sensor pair being one of the plurality of touch sensor pairs and corresponding to an operating mode in which the operating mode element is at the time of the operating mode change action.

Accordingly, with regard to the preceding two paragraphs, a single-change shift (i.e., a valid shift initiation action followed by a single valid shift change action and then no further valid shift change action within the maximum duration time interval after the single valid shift change action) can be carried out or a multiple-change shift (i.e., a valid shift initiation action followed by a series of two or more valid shift change actions and then no further valid shift change action within the maximum duration time interval after the last valid shift change action in the series) can be carried out.

In some embodiments according to the present inventive subject matter, which can include or not include, as suitable, any of the other features described herein, in order for an action to qualify as an operating mode change action, it is necessary that the shift-to sensor pair be adjacent to the current mode touch sensor pair. For example, where there are five touch sensor pairs and the five touch sensor pairs are arranged in a sequence such that moving in the first direction from the first touch sensor pair to the fifth touch sensor pair, the sequence of touch sensor pairs is the first touch sensor pair, followed by the second touch sensor pair, followed by third sensor pair, followed by the fourth sensor pair and then the fifth sensor pair, the second touch sensor pair is adjacent to the first touch sensor pair, the third touch sensor pair is adjacent to the second touch sensor pair, the fourth touch sensor pair is adjacent to the third touch sensor pair, the fifth touch sensor pair is adjacent to the fourth touch sensor pair, the fourth touch sensor pair is adjacent to the fifth touch sensor pair, the third touch sensor pair is adjacent to the fourth touch sensor pair, the second touch sensor pair is adjacent to the third touch sensor pair, and the first touch sensor pair is adjacent to the second touch sensor pair. In such embodiments, if a valid shift initiation action were followed by an operator touching a touch sensor pair that is not adjacent to the touch sensor pair that was touched during the shift initiation action, the operating mode would not be changed. If a valid shift initiation were followed by one or more valid operating mode change actions (e.g., in the layout described in the present paragraph, a shift initiation action in which the first touch sensor pair are touched, followed by (within the maximum duration time interval) an operating mode change action in which the second touch sensor pair are touched, followed by (within the maximum duration time interval) an operating mode change action in which the third touch sensor pair are touched, followed by (within the maximum duration time interval) an operating mode change action in which the second touch sensor pair are touched, followed by (within the maximum duration time interval) the fourth touch sensor pair being touched, the first three operating mode change actions are valid (because the respective touch sensor pairs that were touched are adjacent to the touch sensor pair that was touched in the preceding operating mode change action), and the touching of the fourth touch sensor is not a valid operating mode change action, and so the operating mode element would move to and remain in the operating mode corresponding to the second touch sensor pair.

In a representative embodiment that includes the features described in the preceding paragraph, the shift device is a shift device for a motor vehicle, the first through fifth touch sensor pair correspond respectively to park (i.e., a park operating mode), reverse (i.e., a reverse operating mode), neutral (i.e., a neutral operating mode) and drive (i.e., a drive operating mode). In such an embodiment, it is not possible to shift directly from park to neutral, from park to drive, from part to low, from reverse to drive, from reverse to low, from neutral to low, from low to neutral, from low to reverse, from low to park, from drive to reverse, from drive to park or from neutral to park. Thus, for example, in order to shift from park to drive, it is necessary to first touch each of the touch sensors in the first touch sensor pair (shift initiation action), then (within the maximum duration time interval) to touch each of the touch sensors in the second touch sensor pair (first operating mode change action), then (within the maximum duration time interval) to touch each of the touch sensors in the third touch sensor pair (second operating mode change action), and then (within the maximum duration time interval) to touch each of the touch sensors in the fourth touch sensor pair (third operating mode change action).

In some embodiments according to the present inventive subject matter, which can include or not include, as suitable, any of the other features described herein, in order for an action to qualify as an operating mode change action, it is not necessary that the shift-to sensor pair be adjacent to the current mode touch sensor pair. In such embodiments, after a valid shift initiation action, the operating mode can be changed directly to any other operating mode (not only to the operating mode corresponding to a touch sensor pair that is adjacent to the touch sensor pair that corresponds to the current operating mode).

The maximum duration time interval can be set to any suitable duration (e.g., 1 second, 1.5 seconds, 2 seconds, etc.). In some embodiments according to the present inventive subject matter, which can include or not include, as suitable, any of the other features described herein, the maximum duration time interval can be changed, e.g., by a selection made by an operator or by any other action or detected condition. In some embodiments according to the present inventive subject matter, which can include or not include, as suitable, any of the other features described herein, the maximum duration time interval for one or more shift can differ from the maximum duration time interval of any other shift (e.g., the maximum duration time interval for an operating mode change action from a first operating mode to a second operating mode can differ from the maximum duration time interval for an operating mode change action from the second operating mode to a third operating mode), and in some of such embodiments, there can be any desired number of different maximum duration time intervals and/or any particular maximum duration time interval can be assigned to any desired number of specific operating mode change types (e.g., second operating mode to third operating mode).

In some embodiments according to the present inventive subject matter, which can include or not include, as suitable, any of the other features described herein, the operating mode element emits a shift signal (indicating the operating mode to which the operating mode element has changed) without waiting for the maximum duration time interval (or the longest maximum duration time interval for any valid operating mode change action from the current operating mode) to elapse (e.g., it emits the shift signal immediately after making an operating mode change).

In some embodiments according to the present inventive subject matter, which can include or not include, as suitable, any of the other features described herein, the operating mode element waits for at least the maximum duration time interval (or the longest maximum duration time interval for any valid operating mode change action from the current operating mode) to elapse before it emits a shift signal (indicating the operating mode to which the operating mode element has changed), such that where a sequence of a plurality of operating mode change actions occur after a shift initiation action (i.e., each within the maximum duration time interval or each within the relevant maximum duration time interval), the operating mode element sends only a single shift signal, indicating the operating mode to which the operating mode element has changed at the end of such sequence.

In some embodiments according to the present inventive subject matter, which can include or not include, as suitable, any of the other features described herein, the shift device comprises a sensor housing that comprises at least a first recessed region and a second recessed region, each of the touch sensors comprises a respective touch sensor contact, and the touch sensor contacts of the first series of touch sensors and the first recessed region together define a first recess (and the touch sensor contacts of the second series of touch sensors and the second recessed region together define a second recess). By providing a recess in which the touch sensor contacts are located, an operator can more easily find the touch sensor contacts (e.g., without looking at the touch sensors or by merely glancing at the shift device. In any of such embodiments, the grooves can be of any suitable shape, e.g., they can extend substantially straight and parallel to each other, or they can each have different contours in different regions (and the respective contour(s) of one groove can differ from the respective contour(s) of the other groove). In some of such embodiments:
a first portion of the first recess is in a first region,
the first region is defined by first and second (imaginary) planes that (i) are perpendicular to the first direction, and (ii) are located such that the first touch sensor pair is in the first region and no other touch sensor pair is in the first region,
a second portion of the first recess is in a second region,
the second region is defined by the second plane and a third (imaginary) plane,
the third plane (iii) is perpendicular to the first direction, and (iv) is located such that the second, third and fourth touch sensor pairs are in the second region and no other touch sensor pair is in the second region, and one or more of the following features is satisfied:
a contour of the first recess in the first portion of the first recess differs from a contour of the first recess in the second portion of the first recess;
a plane of substantial symmetry of the first recess in the first portion differs from a plane of substantial symmetry of the first recess in the second portion;
a distance between (a) a fifth (imaginary) plane that is perpendicular to the second direction and that extends through each of the touch sensors in the first series and (b) a location in the first recess and in the first portion that is at least as far, in the second direction, from the fifth plane as any other location in the first recess and in the first portion;
   differs from a distance between (c) the fifth plane and (d) a location in the first recess and in the second portion that is at least as far, in the second direction, from the fifth plane as any other location in the first recess and in the second portion; or
   a maximum width, in the second direction, of the first portion of the first recess, is less than a maximum width, in the second direction, of the second portion of the first recess.

In some embodiments according to the present inventive subject matter, which can include or not include, as suitable, any of the other features described herein, the shift device comprises a protruding region between the first series of touch sensors and the second series of touch sensors. In some of such embodiments, the protruding region is raised merely in relation to the touch sensors (and/or in relation to contacts of the touch sensors). In any of such embodiments, the protruding region can extend at least substantially along the entire distance of a region between the first series and the second series or only part of such distance, and the protruding region can comprise a single continuous structure or multiple structures spaced from each other by any distance.

In some embodiments according to the present inventive subject matter, which can include or not include, as suitable, any of the other features described herein, the shift device comprises a sensor housing that comprises at least a first recessed region and a second recessed region, each of the touch sensors comprises a respective touch sensor contact, and the touch sensor contacts of the first series of touch sensors, the first recessed region together define a first recess, the touch sensor contacts of the second series of touch sensors and the second recessed region together define a second recess, and the shift device comprises a protruding region between the first series of touch sensors and the second series of touch sensors. In some of such embodiments, the protruding region is raised merely in relation to the touch sensors (and/or in relation to contacts of the touch sensors). In some of such embodiments the sensor housing comprises a housing surface that substantially defines a first plane, the first and second recess are recessed into the housing surface behind the first plane, and the protruding region has a protruding surface that is substantially in the first plane.

In some embodiments according to the present inventive subject matter, which can include or not include, as suitable, any of the other features described herein, the shift device comprises a protruding region between the first series of touch sensors and the second series of touch sensors, and indicia are provided on the protruding region, each indicia providing information that corresponds to the touch sensors between which the indicia is located.

In some embodiments according to the present inventive subject matter, which can include or not include, as suitable, any of the other features described herein, the plurality of operating modes correspond to transmission modes of the motor vehicle. In some of such embodiments:
the plurality of touch sensor pairs comprises at least a first touch sensor pair, a second touch sensor pair that is adjacent to the first touch sensor pair, a third touch sensor pair that is adjacent to the second touch sensor pair, and a fourth touch sensor pair that is adjacent to the third touch sensor pair
the equipment is a motor vehicle,
the plurality of operating modes comprises a park mode, a reverse mode, a neutral mode and a drive mode,
the first touch sensor pair corresponds to said park mode,
the second touch sensor pair corresponds to said reverse mode,
the third touch sensor pair corresponds to said neutral mode, and
the fourth touch sensor pair corresponds to said drive mode.

In some embodiments according to the present inventive subject matter, which can include or not include, as suitable, any of the other features described herein, one or more physical irregularities are provided between touch sensors. Such physical irregularities can assist a user in knowing where the touch sensors are located without looking at them. In some of such embodiments:
the plurality of touch sensor pairs comprises at least a first touch sensor pair, a second touch sensor pair that is adjacent to the first touch sensor pair, a third touch sensor pair that is adjacent to the second touch sensor pair, and a fourth touch sensor pair that is adjacent to the third touch sensor pair,
the first touch sensor pair comprises a first series first touch sensor and a second series first touch sensor,
the second touch sensor pair comprises a first series second touch sensor and a second series second touch sensor,
the third touch sensor pair comprises a first series third touch sensor and a second series third touch sensor,
the first touch sensor pair comprises a first series fourth touch sensor and a second series fourth touch sensor,
the device further comprises:
   a first surface irregularity between the first series first touch sensor and the first series second touch sensor,
   a second surface irregularity between the first series second touch sensor and the first series third touch sensor,
   a third surface irregularity between the first series third touch sensor and the first series fourth touch sensor,
   a fourth surface irregularity between the second series first touch sensor and the second series second touch sensor,
   a fifth surface irregularity between the second series second touch sensor and the second series third touch sensor, and
   a sixth surface irregularity between the second series third touch sensor and the second series fourth touch sensor.

Such surface irregularities, where provided, can be any suitable surface irregularity, e.g., a raised portion, a recessed portion or a combination thereof.

In some embodiments according to the present inventive subject matter, which can include or not include, as suitable, any of the other features described herein, the shift device comprises one or more feature that confirms that a shift is being (or has been, or will be) executed, e.g., that alerts an operator that a shift initiation action and one or more operating mode change actions have been correctly entered and received by the shift device (i.e., a shift confirmation). For example, such a feature can be a haptic feature (such as a vibration, e.g., created by any element that can be caused to vibrate, such as a solenoid or a piezoelectric element), emission of sound and/or emission of light.

A haptic feature (for shift confirmation) can be provided at any suitable location (e.g., a vibrating element can be provided at or near one or more pairs of touch sensors, and each vibrating element can be caused to vibrate when the shift device shifts to the operating mode that corresponds to the pair of touch sensors to which that vibrating element is at or near. Persons of skill in the art are familiar with a wide variety of haptic features, and any such haptic feature can be employed in shift devices in accordance with the present inventive subject matter.

An emission of sound (for shift confirmation) can be provided at any suitable location. In some embodiments, the emission of sound can be indicative of the operating mode to which the shift device has been changed.

An emission of light (for shift confirmation) can be provided at any suitable location. In some embodiments, the emission of light can be indicative of the operating mode to which the shift device has been changed. For example, in a specific embodiment of a shift device for an automobile, lights in the shapes of P, R, N, D and L (or lights behind cutouts corresponding to those letters) can be provided between the touch sensors of touch sensor pairs corresponding to park, reverse, neutral, drive, and low, respectively (e.g., on a protruding region, the protruding region between the first and second series of touch sensors), and the respective light(s) can be illuminated upon the shift device shifting to the respective operating modes. In some embodiments, indicia representing the different operating modes can be illuminated continuously and then the color can be changed, e.g., in a specific embodiment of a shift device for an automobile, lights in the shapes of P, R, N, D and L (or lights behind cutouts corresponding to those letters) can be provided between the touch sensors of touch sensor pairs corresponding to park, reverse, neutral, drive, and low, respectively (e.g., on a protruding region, the protruding region between the first and second series of touch sensors), and the lights can be illuminated continuously (e.g., whenever the vehicle is running), with each light emitting white light except for the light corresponding to the operating mode in which the shift device currently is, which emits red light (or any other color light, e.g., green light).

In some embodiments according to the present inventive subject matter, which can include or not include, as suitable, any of the other features described herein, the shift device can comprise software to accommodate for factors that may affect the normal operation of the shift device. For example, the sensitivity of the touch sensors can be adjustable. As an example, if a component of the shift device detects that the operator is wearing gloves (or if the operator inputs such information), the capacitance (in a capacitance switch touch sensor) required to trigger the switch in the touch sensor can be decreased such that the reduction (caused by the gloves) in the change in capacitance resulting from the user touching the touch sensors is sufficient to register as a touch. As another example, if a component of the shift device detects a spill of liquid, the capacitance (in a capacitance switch touch sensor) required to trigger the switch in the touch sensor can be increased such that the change in capacitance (caused by the liquid) resulting from the liquid touching the touch sensors is not sufficient to register as a touch. In other situations, the sensitivity of the touch sensors (e.g., the change in capacitance or resistance required to trigger a switch) can be adjusted by a user.

In some embodiments according to the present inventive subject matter, which can include or not include, as suitable, any of the other features described herein, there is provided an article of equipment comprising:
a shift device as described herein, and
a system that has a plurality of system modes, each system mode corresponding to one of the operating modes of the shift device,
wherein upon receiving a shift signal from the operating mode element, the system changes to a system mode that corresponds to the operating mode indicated in the shift signal. In any of such embodiments, the shift device can be placed in any suitable position with respect to the article of equipment. For example, in embodiments in which the article of equipment is a motor vehicle, the shift device can be positioned in the instrument panel for the motor vehicle, the steering wheel for the motor vehicle, the center console for the motor vehicle, or in any other suitable location in the motor vehicle (e.g., in the car doors, in surfaces behind textiles, or in any location that might be suitable in connection with an autonomous vehicle or semi-autonomous vehicle). In some of such embodiments, the article of equipment waits for at least the maximum duration time interval (or the longest maximum duration time interval for any valid operating mode change action from the current operating mode) to elapse (after receiving a shift signal) before it shifts, and in others of such embodiments (e.g., embodiments in which the operating mode element waits for at least the maximum duration time interval (or the longest maximum duration time interval for any valid operating mode change action from the current operating mode) to elapse (after receiving a shift signal) before it emits a shift signal), the article of equipment can shift without waiting for at least the maximum duration time interval (or the longest maximum duration time interval for any valid operating mode change action from the current operating mode) to elapse before it shifts, e.g., it can shift substantially immediately upon receiving a shift signal.

In some embodiments according to the present inventive subject matter, which can include or not include, as suitable, any of the other features described herein, there is provided an article of equipment comprising:
a shift device as described herein, and
a system that has a plurality of system modes, each system mode corresponding to one of the operating modes of the shift device as discussed above, and in which one or more condition in the vehicle or in the operation of the vehicle affects the options available to the shift device (e.g., in order for the shift device to shift from a park operating mode into any other operation mode, the vehicle brake must be applied, etc.).

As noted above, the present inventive subject matter also provides a method of shifting, comprising:
performing a shift initiation action comprising simultaneously touching both touch sensors in a first touch sensor pair corresponding to a first operating mode, the first touch sensor pair being among a plurality of touch sensor pairs in any shift device as described herein, e.g., a device for issuing shift commands upon receiving valid shift sequences, said first operating mode being selected from among a plurality of operating modes, said current operating mode being an operating mode in which said device is currently operating,
and then, within a maximum duration time interval since said simultaneously touching both touch sensors in the first touch sensor pair, performing at least one operating mode change action (as described herein) beginning with a first operating mode change action, said first operating mode change action comprising simultaneously touching both touch sensors in a second touch sensor pair corresponding to a second operating mode, the second touch sensor pair being among the plurality of touch sensor pairs, the second operating mode being among the plurality of operating modes,
each of said plurality of touch sensor pairs comprising one of a first series of touch sensors and one of a second series of touch sensors, the first series comprising at least three touch sensors arranged in a first pattern that extends in a first direction, the second series comprising at least three touch sensors arranged in a second pattern that extends in the first direction, the second pattern extending substantially parallel to the first pattern,
the first pattern and the second pattern aligned to provide said plurality of touch sensor pairs,
each touch sensor pair comprising a touch sensor of the first series and a touch sensor of the second series,
for each touch sensor pair, the touch sensor of the first series and the touch sensor of the second series are aligned in a second direction, the second direction substantially perpendicular to the first direction,
each touch sensor pair corresponding to a respective one of said plurality of operating modes.

Shift devices in accordance with the present inventive subject matter can provide numerous advantages. Such advantages include (and are not limited to):
the requirement for both sensors to be touched results in a lower incidence of unintended shifting;
the shift device is easy to operate (it requires only touching by an operator);
the touch sensors (and/or where present, the sensor housing, the touch sensor contacts, etc.) can be a closed surface, thereby preventing liquid and other materials (e.g., crumbs and dust) from getting into the shift device or components thereof;
the shift device can be made without buttons (or with fewer buttons);
the shift device can result in a system (e.g., a motor vehicle) with fewer buzz, squeal and rattle (BSR);
the shift device has, and/or can contribute to a system (e.g., a motor vehicle), that has fewer moving parts;
the shift device can be mounted in any suitable location (e.g., it can be easily integrated into instrument panel, a steering wheel, etc., and where it is mounted anywhere other than in the vehicle console, it is possible to provide a bench seat for the front seats of the vehicle, or space between front seats is free of a shift device;
in a system in which the shift device is used with a motor vehicle, transmission modes of the vehicle can be arranged in a way that is similar to the way transmission modes have been arranged in the past (e.g., in the sequence: Park; Reverse; Neutral: Drive; and Low), e.g., in the sequence that they have been arranged on mechanical levers in prior vehicles.

Embodiments in accordance with the present inventive subject matter are described herein in detail in order to provide exact features of representative embodiments that are within the overall scope of the present inventive subject matter. The present inventive subject matter should not be understood to be limited to such detail.

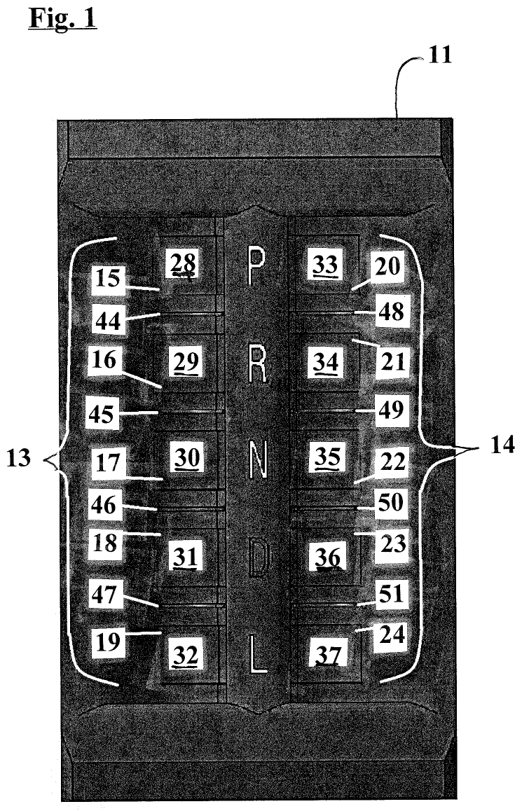

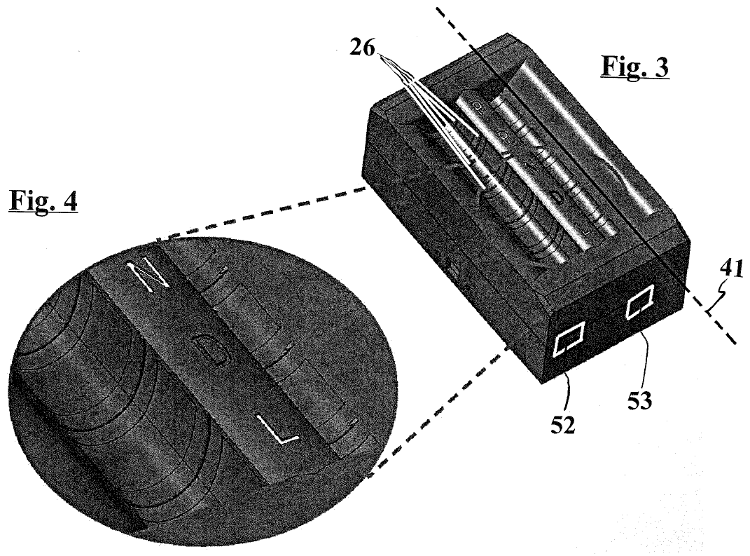

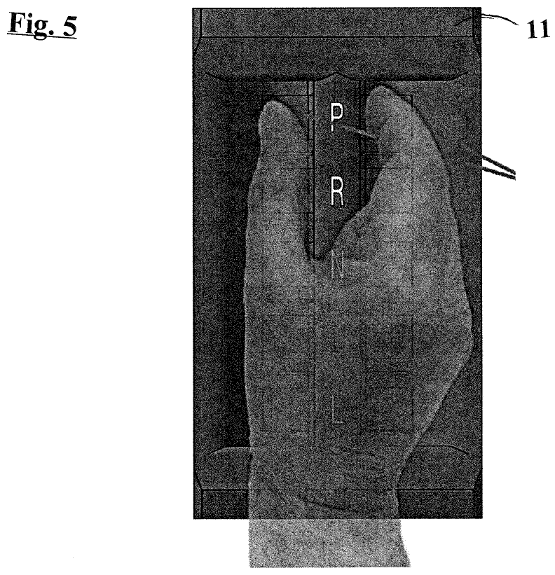

FIGS. 1-6 depict a first embodiment of a shift device 10 (i.e., a device for issuing shift commands upon receiving valid shift sequences) in accordance with some aspects of the present inventive subject matter. The shift device 10 comprises an operating mode element 100 that is configured to shift among a plurality of operating modes, and to emit a shift signal upon shifting from one of the plurality of operating modes to another of the plurality of operating modes, the shift signal indicating the operating mode to which the operating mode element 100 has shifted.

In this particular embodiment, the shift device 10 is a shift device for a motor vehicle, and the operating mode element 100 is configured to shift among five operating modes (a park operating mode, a reverse operating mode, a neutral operating mode, a drive operating mode and a low operating mode), and, upon shifting, to send a shift signal indicating the operating mode to which the operating mode element has shifted, such shift signals causing the motor vehicle to shift among five transmission modes (a park transmission mode, a reverse transmission mode, a neutral transmission mode, a drive transmission mode and a low transmission mode). Each of the five operating modes of the operating mode element 100 corresponds to a respective one of the five transmission modes of the motor vehicle, i.e., the park operating mode of the operating mode element 100 corresponds to the park transmission mode of the vehicle, the reverse operating mode of the operating mode element 100 corresponds to the reverse transmission mode of the vehicle, etc.

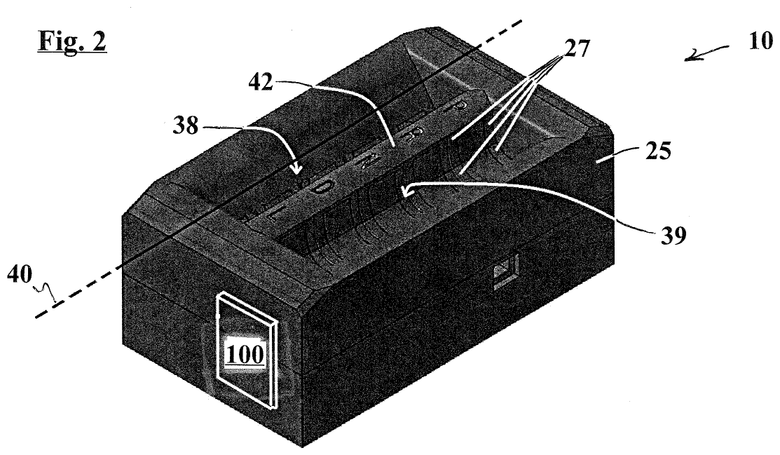

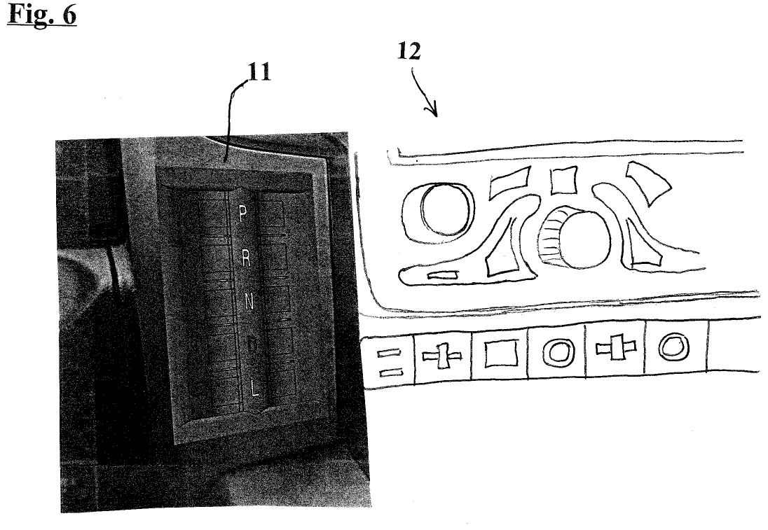

The shift device 10 comprises a sensor housing 25 (see FIG. 2) that comprises a housing face 11. The shift device 10 can be mounted in any suitable region of the motor vehicle, and can be mounted in any suitable orientation. In FIG. 6, the shift device 10 is shown mounted in an instrument panel 12 of a motor vehicle, with the housing face 11 oriented substantially vertically.

In the orientation depicted in FIG. 1, the plane of the page is in a vertical plane, i.e., the housing face 11 is oriented vertically.

Referring to FIG. 1, the shift device 10 comprises a first series of touch sensors 13 and a second series of touch sensors 14. The first series of touch sensors 13 consists of a first series first touch sensor 15, a first series second touch sensor 16, a first series third touch sensor 17, a first series fourth touch sensor 18, and a first series fifth touch sensor 19. The second series of touch sensors 14 consists of a second series first touch sensor 20, a second series second touch sensor 21, a second series third touch sensor 22, a second series fourth touch sensor 23, and a second series fifth touch sensor 24.

In this embodiment, each of the touch sensors 15-24 is a capacitance switch.

The touch sensors 15-19 in the first series 13 are arranged in a first pattern that extends in a first direction (i.e., vertically in the orientation depicted in FIG. 1). The touch sensors in the first series 13 are aligned (i.e., there is at least one straight line that would pass through each of the touch sensors 15-19). Moreover, a first line is substantially co-linear with respective a first edge (the left side in the orientation depicted in FIG. 1) of each of the touch sensors 15-19, and a second line is substantially co-linear with a respective second edge (the right side in the orientation depicted in FIG. 1) of each of the touch sensors 15-19.

The touch sensors 20-24 in the second series 14 are arranged in a second pattern that extends in the first direction (i.e., vertically in the orientation depicted in FIG. 1, and therefore substantially parallel to the first pattern). The touch sensors in the second series 14 are aligned (i.e., there is at least one straight line that would pass through each of the touch sensors 20-24). Moreover, a third line is substantially co-linear with a respective first edge (the left side in the orientation depicted in FIG. 1) of each of the touch sensors 20-24, and a fourth line is substantially co-linear with a respective second edge (the right side in the orientation depicted in FIG. 1) of each of the touch sensors 20-24.

As shown in FIG. 1, the first pattern and the second pattern are aligned to provide a series of five touch sensor pairs, i.e., a first touch sensor pair consisting of the first series first touch sensor 15 and the second series first touch sensor 20, a second touch sensor pair consisting of the first series second touch sensor 16 and the second series second touch sensor 21, a third touch sensor pair consisting of the first series third touch sensor 17 and the second series third touch sensor 22, a fourth touch sensor pair consisting of the first series fourth touch sensor 18 and the second series fourth touch sensor 23, and a fifth touch sensor pair consisting of the first series fifth touch sensor 19 and the second series fifth touch sensor 24.

For each of the touch sensor pairs, the touch sensor of the first series and the touch sensor of the second series are aligned in a second direction, i.e., horizontally (and thus perpendicular to the direction in which the touch sensors 15-19 in the first pattern are arranged and perpendicular to the direction in which the touch sensors 20-24 in the second pattern are arranged). For example, the first series first touch sensor 15 and the second series first touch sensor 20 are aligned horizontally. In addition, for each of the touch sensor pairs, one line is substantially co-linear with a respective first edge (the upper side in the orientation depicted in FIG. 1) of both of the touch sensors, and another line is substantially co-linear with a respective second edge (the bottom side in the orientation depicted in FIG. 1) of both of the touch sensors.

The first series of touch sensors 13 and the second series of touch sensors 14 are mounted in the sensor housing 25. The sensor housing comprises a first recessed region 26 and a second recessed region 27.

Each of the touch sensors comprises a respective sensor contact, i.e., the first series first touch sensor 15 comprises a first series first touch sensor contact 28, the first series second touch sensor 16 comprises a first series second touch sensor contact 29, the first series third touch sensor 17 comprises a first series third touch sensor contact 30, the first series fourth touch sensor 18 comprises a first series fourth touch sensor contact 31, the first series fifth touch sensor 19 comprises a first series fifth touch sensor contact 32, the second series first touch sensor 20 comprises a second series first touch sensor contact 33, the second series second touch sensor 21 comprises a second series second touch sensor contact 34, the second series third touch sensor 22 comprises a second series third touch sensor contact 35, the second series fourth touch sensor 23 comprises a second series fourth touch sensor contact 36, and the second series fifth touch sensor 24 comprises a second series fifth touch sensor contact 37.

Each touch sensor senses a touch upon its respective contact being touched by a user (e.g., a human who is operating the motor vehicle), i.e., the first series first touch sensor 15 senses a touch when a user touches the first series first touch sensor contact 28, the first series second touch sensor 16 senses a touch when a user touches the first series second touch sensor contact 29, etc.

The sensor contacts 28-32 of the first series of touch sensors 13 and the first recessed region 26 together define a first recess 38, and the sensor contacts 33-37 of the second series of touch sensors 14 and the second recessed region 27 together define a second recess 39.

An axis of the first recess 40 is parallel to the first direction (i.e, vertical in the orientation depicted in FIG. 1), and an axis of the second recess 41 is likewise parallel to the first direction (i.e, similarly, vertical in the orientation depicted in FIG. 1).

The first recess 38 and the second recess 39 are substantially straight, i.e., the edges of the recess form substantially straight line segments, and line segments along the sides of the recesses at constant depths from the housing face 11 are also substantially straight.

The sensor housing 25 further comprises a protruding region 42 (i.e., protruding relative to the first recess 38 and the second recess 39) which is between the first series of touch sensors 13 and the second series of touch sensors 14 (likewise, between the first recess 38 and the second recess 39). The protruding region 42 comprises respective indicia between the respective touch sensors of each touch sensor pair, i.e., the letter P (representing “park” operating mode and “park” transmission mode) is between the first series first touch sensor 15 and the second series first touch sensor 20, the letter R (representing “reverse” operating mode and “reverse” transmission mode) is between the first series second touch sensor 16 and the second series second touch sensor 21, the letter N (representing “neutral” operating mode and “neutral” transmission mode) is between the first series third touch sensor 17 and the second series third touch sensor 22, the letter D (representing “drive” operating mode and “drive” transmission mode) is between the first series fourth touch sensor 18 and the second series fourth touch sensor 23, and the letter L (representing “low” operating mode and “low” transmission mode) is between the first series fifth touch sensor 19 and the second series fifth touch sensor 24. In this embodiment, the respective indicia (“P”, “R”, “N”, “D” and “L”) are made of light emitting diodes (LEDs) that emit white light at all time that the vehicle is running, except that the indicia that corresponds to the operating mode in which the shift device currently is operating emit red light. Persons of skill in the art are familiar with various light emitters and with circuitry through which light emitters can be caused to illuminate, and can be cause to emit a different color upon the occurrence of any particular event (e.g., the shift device shifting to a corresponding operating mode).

The protruding region 42 extends along the entire distance of a region between the first series of touch sensors 13 and the second series of touch sensors 14 (the first series of touch sensors 13 and the second series of touch sensors 14 comprising all of the touch sensors in the shift device 10), such that any plane (i.e., imaginary plane) that passes through any portion of the first series of touch sensors 13 and any portion of the second series of touch sensors 14 also passes through the protruding region 42.

Each of the five touch sensor pairs corresponds to a respective one of the five respective operating modes of the motor vehicle (the five operating modes corresponding to the respective five transmission modes). The first touch sensor pair corresponds to the “park” operating mode. The second touch sensor pair corresponds to the “reverse” operating mode. The third touch sensor pair corresponds to the “neutral” operating mode. The fourth touch sensor pair corresponds to the “drive” operating mode. The fifth touch sensor pair corresponds to the “low” operating mode.

Accordingly, each of the letters “P”, “R”, “N”, “D” and “L” on the center region is located between the respective touch sensor pair that corresponds to the operating mode that the letter represents (i.e., “P” represents “park”, and “P” is between the two touch sensor pairs that correspond to the park operating mode, “N” represents “neutral”, and “N” is between the two touch sensor pairs that correspond to the neutral operating mode, etc.).

The operating mode element 100 is depicted schematically in FIG. 2 as a circuit board positioned within the sensor housing 25. Signals from the touch sensors 15-24 are supplied to the operating mode element 100, and the operating mode element 100 changes from one operating mode to another and sends at least one shift signal to the transmission of the motor vehicle (to cause the transmission of the motor vehicle to change to the transmission mode that corresponds to the operating mode to which the operating mode element 100 has shifted) upon the occurrence of a valid shift sequence, the criteria for whether a sequence of actions is a valid shift sequence being detailed below.

An important aspect in determining whether a sequence of action is a valid shift sequence involves whether a touch sensor pair is “adjacent” to another touch sensor pair. A touch sensor pair is “adjacent” to another touch sensor pair if (consistent with the definition of “adjacent” described herein), for each touch sensor in the two touch sensor pairs, there is no touch sensor between it and the corresponding touch sensor of the other touch sensor pair (i.e., in the embodiment depicted in FIGS. 1-6, the second touch sensor pair is adjacent to the first touch sensor pair, the third touch sensor pair is adjacent to the second touch sensor pair, the fourth touch sensor pair is adjacent to the third touch sensor pair, and the fifth touch sensor pair is adjacent to the fourth touch sensor pair; likewise, the fourth touch sensor pair is adjacent to the fifth touch sensor pair, the third touch sensor pair is adjacent to the fourth touch sensor pair, the second touch sensor pair is adjacent to the third touch sensor pair, and the first touch sensor pair is adjacent to the second touch sensor pair).

A valid shift sequence consists of (1) a valid shift initiation, and (2) one or more valid shift change actions (i.e., a single valid shift change action or a series of two or more valid shift change actions).

A valid shift initiation occurs when the two touch sensors in the touch sensor pair that corresponds to the operating mode that the operating mode element 100 is currently in simultaneously sense a touch (e.g., when a user touches the respective contacts for each of the touch sensors in that pair).

A valid shift change action occurs when the two sensors, in a touch sensor pair (a “shift-to” touch sensor pair) that is adjacent to the touch sensor pair that corresponds to the operating mode that the operating mode element 100 is currently in, simultaneously sense a touch within a time period of not longer than a pre-selected maximum duration time interval (e.g., two seconds) since a valid shift initiation or since the most recent valid shift change action, whichever is more recent. Upon the occurrence of a valid shift change action, the operating mode of the operating mode element 100 changes to the operating mode that corresponds to the “shift-to” touch sensor pair, and the operating mode element 100 emits a shift signal indicating that it has shifted to the operating mode that corresponds to the “shift-to” touch sensor pair.

In actual practice, there is usually a brief (and in some cases, very brief, e.g., ephemeral) lag between the occurrence of a valid shift change action and the changing of the operating mode of the operating mode element 100. For purposes of determining whether a touch sensor pair is adjacent to the touch sensor pair that corresponds to the operating mode that the operating mode element 100 is currently in, the changing of the operating mode to the operating mode that corresponds to the “shift-to” touch sensor pair (upon the occurrence of a valid shift change action) is treated as if it were instantaneous (i.e., a series of shift change actions would not be invalid solely because the shift change actions are executed more rapidly than the operating mode changes can occur).

Accordingly, a valid shift sequence can be a single-change shift (i.e., a valid shift initiation followed by a single valid shift change action and then no further valid shift change action within the maximum duration time interval after the single valid shift change action), or a multiple-change shift (i.e., a valid shift initiation followed by a series of two or more valid shift change actions and then no further valid shift change action within the maximum duration time interval after the last valid shift change action in the series).

In some embodiments of the present inventive subject matter, a shift device can be configured such that a valid shift sequence (for a single-change shift) consists of an action in which both touch sensors in the touch sensor pair (initial touch sensor pair) corresponding to the current operating mode simultaneously sense a touch, and then, within a span of time that is not longer than the maximum duration time interval (i.e., since said both of the touch sensors in the initial touch sensor pair simultaneously sensed a touch), an action in which both of the touch sensors in a touch sensor pair that is adjacent to the initial touch sensor pair simultaneously sense a touch. The expression “consists of” in the present paragraph relates to touch sensors sensing touch, i.e., an “action” relates to touch sensors sensing a touch, and so it means that the occurrence of any other touch sensor sensing a touch (e.g., a touch sensor that is not one of the initial touch sensor pair and not one of the adjacent touch sensor pair sensing a touch at a time that is between the time that the touch sensors in the initial touch sensor pair sense a touch and the time that the touch sensors in the adjacent touch sensor pair sense a touch) would mean that there has not been a valid shift sequence (the occurrence of anything other than a touch sensor sensing a touch does not affect whether a sequence consists of the specified things).

In some embodiments, a shift device in accordance with the present inventive subject matter can be configured such that a valid shift sequence (for a multiple-change shift) consists of:
an action in which both touch sensors in the touch sensor pair (initial touch sensor pair) corresponding to the current operating mode simultaneously sensing a touch,
then, within a span of time that is not longer than the maximum duration time interval since said initial touch sensor pair simultaneously sensing a touch, an action consisting of both sensors in a touch sensor pair (updated touch sensor pair) that is adjacent to said initial touch sensor simultaneously sensing a touch,
and then one or more subsequent actions, each such subsequent action consisting of:
   both sensors in a touch sensor pair that is adjacent to the current updated touch sensor pair simultaneously sensing a touch within a span of time that is not longer than the maximum duration time interval since the previous action.

In other words, a valid shift sequence for a multiple-change shift consists of an occurrence of both touch sensors in the touch sensor pair corresponding to the current operating mode simultaneously sensing a touch, and then a series of one or more occurrences of both touch sensors in a touch sensor pair simultaneously sensing touch, each occurrence occurring not more than the maximum duration time interval from the previous occurrence, and for each occurrence, the touch sensor pair that sense touch are adjacent to the touch sensor pair that sensed touch in the previous occurrence.

Again, the expression “consists of” in each of the preceding two sentences relates to touch sensors sensing touch, i.e., an “action” relates to touch sensors sensing a touch, and so it means that the occurrence of any other touch sensor sensing a touch (e.g., a touch sensor that is not one of the touch sensor pair in any of the occurrences) between the time that the touch sensors in two occurrences occur, would mean that a valid shift change action has not occurred, and in order for the operating mode to be further changed, a new valid shift sequence would have to occur (i.e., staring with both touch sensors in the touch sensor pair (initial touch sensor pair) corresponding to the current operating mode simultaneously sensing a touch)(the occurrence of anything other than a touch sensor sensing a touch does not affect whether a sequence consists of the specified things).

For example, a valid multiple-change shift sequence can consist of:
(1) both of the touch sensors in a touch sensor pair (first-sensing touch sensor pair) corresponding to the current operating mode simultaneously sensing a touch,
(2) then, within a span of time that is not longer than the maximum duration time interval since said both of the touch sensors in the first-sensing touch sensor pair simultaneously sensing a touch, both of the touch sensors in a touch sensor pair (second-sensing touch sensor pair) that is adjacent to the first-sensing touch sensor pair simultaneously sensing a touch,
(3) and then, within a span of time that is not longer than the maximum duration time interval since said both of the touch sensors in the second-sensing touch sensor pair simultaneously sensing a touch, both of the touch sensors in a touch sensor pair that is adjacent to the second-sensing touch sensor pair simultaneously sensing a touch.

In the present embodiment, upon starting the motor vehicle, the shift device 10 is in the park operating mode and the motor vehicle is in the park transmission mode. Thus, in order to initially shift the shift device 10 out of the park operating mode (and to shift the motor vehicle out of the park transmission mode, it is necessary:
for both of the touch sensors in the first touch sensor pair (i.e., the first series first touch sensor 15 and the second series first touch sensor 20) to sense a touch simultaneously (e.g., for a user to touch the first series first touch sensor contact 28 and the second series first touch sensor 33 simultaneously),
and then, within a maximum duration time interval (in this embodiment, two seconds), for both of the touch sensors in the second touch sensor pair (i.e., the first series second touch sensor 16 and the second series second touch sensor 21) to sense a touch simultaneously (e.g., for a user to touch the first series second touch sensor contact 29 and the second series second touch sensor 34 simultaneously).

A valid shift sequence for a multiple-change shift can comprise the initial shift out of the park mode (i.e., the first shift after turning the motor vehicle on). Accordingly, for example, a sequence consisting of the following:
(A) a user turns on the motor vehicle;
(B) after five minutes, the user simultaneously touches the first series first touch sensor contact 28 and the second series first touch sensor contact 33;
(C) one second thereafter, the user simultaneously touches the first series second touch sensor contact 29 and the second series second touch sensor contact 34;
(D) one second thereafter, the user simultaneously touches the first series third touch sensor contact 30 and the second series third touch sensor contact 35; and
(E) one second thereafter, the user simultaneously touches the first series fourth touch sensor contact 31 and the second series fourth touch sensor contact 36, is a valid shift sequence, and results in the shift device 10 being shifted to the drive operating mode (i.e., the shift device 10 is in the park operating mode, and the vehicle is in the park transmission mode, upon the motor vehicle being turned on, the shift device 10 shifts to the reverse operating mode upon (C) being completed, the shift device 10 shifts to the neutral operating mode upon (D) being completed, and the shift device 10 shifts to the drive operating mode upon (E) being completed.

A series of valid shift change actions can comprise shifting in either direction among the sequence of park, reverse, neutral, drive and low. Accordingly, for example, a sequence consisting of the following:
(A) the shift device 10 is in the drive operating mode (and the vehicle is in the drive transmission mode);
(B) the user simultaneously touches the first series fourth touch sensor contact 31 and the second series fourth touch sensor contact 36;
(C) one second thereafter, the user simultaneously touches the first series third touch sensor contact 30 and the second series third touch sensor contact 35;
(D) one second thereafter, the user simultaneously touches the first series second touch sensor contact 29 and the second series second touch sensor contact 34; and
(E) one second thereafter, the user simultaneously touches the first series first touch sensor contact 28 and the second series first touch sensor contact 33,
   is a valid shift sequence, and results in the shift device 10 shifting from the drive operating mode to the neutral operating mode upon (C) being completed, the shift device 10 shifting from the neutral operating mode to the reverse operating mode upon (D) being completed, and the shift device 10 shifting from the reverse operating mode to the park operating mode upon (E) being completed.

A series of valid shift change actions can comprise a sequence that comprises shifting in both directions among the sequence of park, reverse, neutral, drive and low during the sequence. Accordingly, for example, a sequence consisting of the following:
(A) the shift device 10 is in the reverse operating mode (and the vehicle is in the reverse transmission mode);
(B) the user simultaneously touches the first series second touch sensor contact 29 and the second series second touch sensor contact 34;
(C) one second thereafter, the user simultaneously touches the first series third touch sensor contact 30 and the second series third touch sensor contact 35;
(D) one second thereafter, the user simultaneously touches the first series fourth touch sensor contact 31 and the second series fourth touch sensor contact 36;
(E) one second thereafter, the user simultaneously touches the first series third touch sensor contact 30 and the second series third touch sensor contact 35;
(F) one second thereafter, the user simultaneously touches the first series second touch sensor contact 29 and the second series second touch sensor contact 34; and
(G) one second thereafter, the user simultaneously touches the first series second touch sensor contact 29 and the second series second touch sensor contact 34,
   is a valid shift sequence, and results in the shift device 10 shifting from the reverse operating mode to the neutral operating mode upon (C) being completed, the shift device 10 shifting from the neutral operating mode to the drive operating mode upon (D) being completed, the shift device 10 shifting from the drive operating mode to the neutral operating mode upon (E) being completed, the shift device 10 shifting from the neutral operating mode to the reverse operating mode upon (F) being completed, and the shift device 10 shifting from the reverse operating mode to the park operating mode upon (G) being completed.

As noted above, there is often a brief (and in some cases, ephemeral) lag between the occurrence of a valid shift change action and the changing of the operating mode of the operating mode element. In addition, there is often a brief lag between the occurrence of a change in the operating mode of the operating mode element and the corresponding change in the transmission mode of the vehicle.

The sensor housing 25 also comprises surface irregularities between touch sensor contacts that are in the same series and that are adjacent to each other, i.e., the sensor housing 25 comprises a first surface irregularity 44 between the first series first touch sensor contact and the first series second touch sensor contact, a second surface irregularity 45 between the first series second touch sensor contact and the first series third touch sensor contact, a third surface irregularity 46 between the first series third touch sensor contact and the first series fourth touch sensor contact, a fourth surface irregularity 47 between the first series fourth touch sensor contact and the first series fifth touch sensor contact, a fifth surface irregularity 48 between the second series first touch sensor contact and the second series second touch sensor contact, a sixth surface irregularity 49 between the second series second touch sensor contact and the second series third touch sensor contact, a seventh surface irregularity 50 between the second series third touch sensor contact and the second series fourth touch sensor contact, and an eighth surface irregularity 51 between the second series fourth touch sensor contact and the second series fifth touch sensor contact (each of these surface irregularities in the form of a raised portion in the shape of an elongated rectangle, i.e., a substantially linear shape).

The shift device 10 also comprises a first vibration element 52 and a second vibration element 53. The shift device 10 is configured to cause the first vibration element 52 and the second vibration element 53 to vibrate upon each occurrence of a valid shift change action.

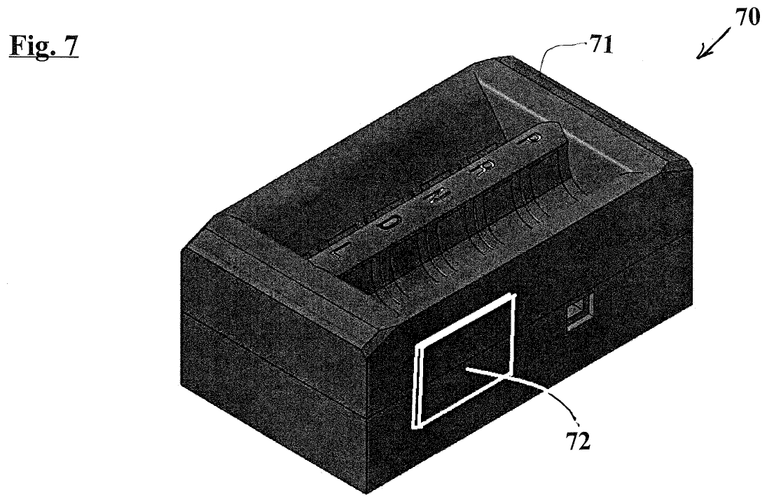

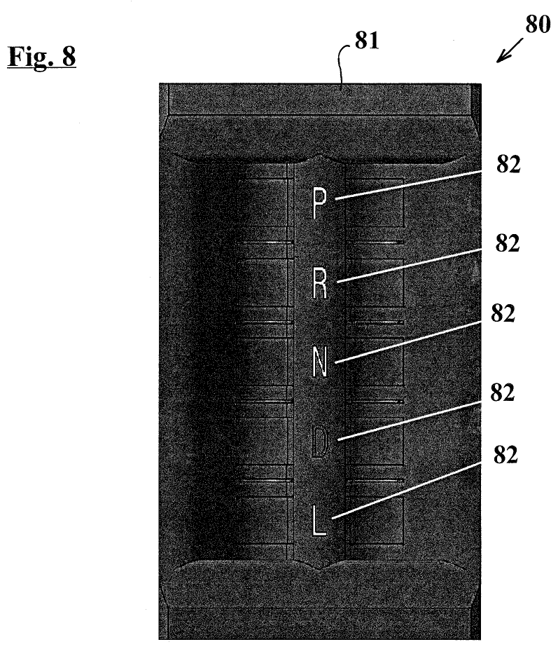

FIG. 7 depicts a housing face 71 of a shift device 70 of a second embodiment in accordance with some aspects of the present inventive subject matter. The shift device 70 depicted in FIG. 7 is identical to the shift device 10 depicted in FIG. 1, except that the shift device 70 depicted in FIG. 7 further comprises a sound emission element 72 that emits sound upon each occurrence of a valid shift change action.

FIG. 8 depicts a housing face 81 of a shift device 80 of a third embodiment in accordance with some aspects of the present inventive subject matter. The shift device 80 depicted in FIG. 8 includes LEDs 82 that can be illuminated to provide indicia of “P”, “R”, “N”, “D” and “L”.

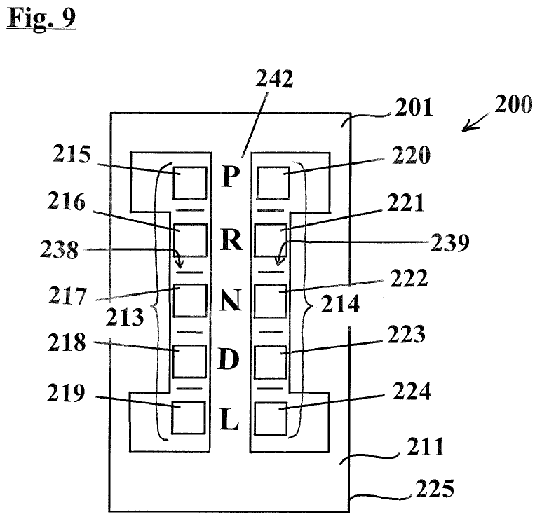

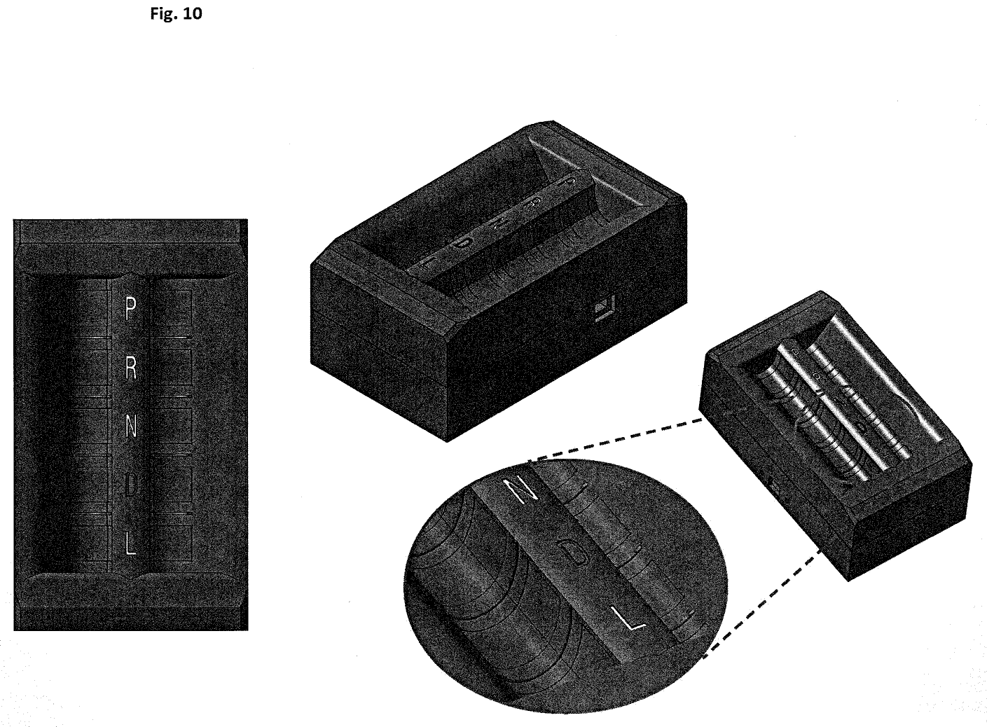

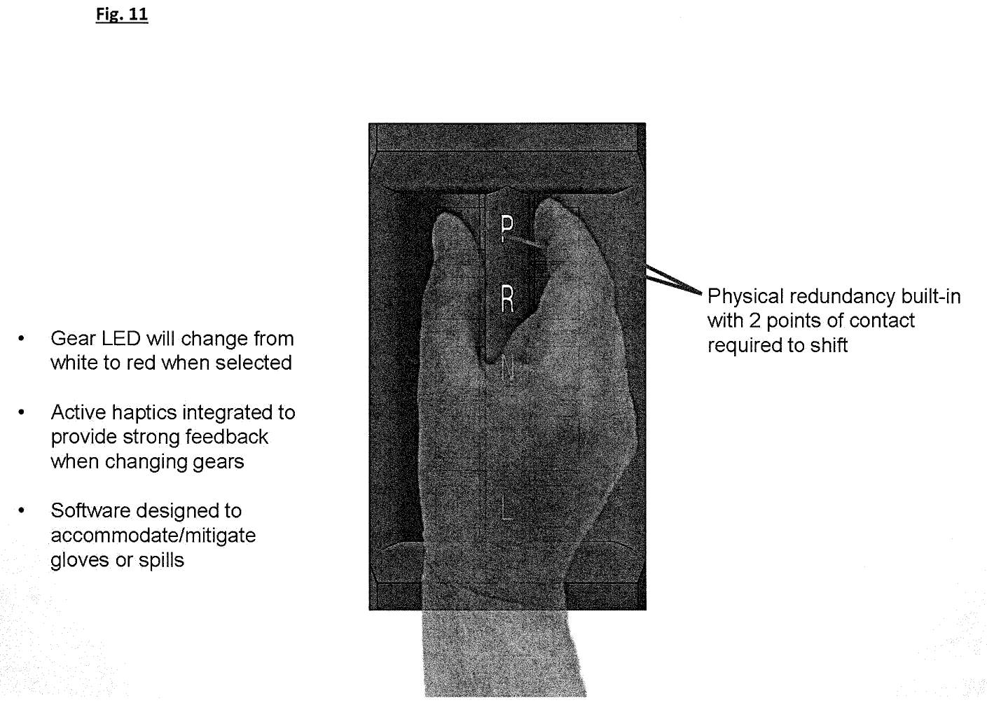

FIG. 9 depicts a housing face 201 of a shift device 200 of a fourth embodiment in accordance with some aspects of the present inventive subject matter.

The shift device 200 is similar to the shift device 10 depicted in FIGS. 1-6, except that the shift device 200 comprises a first recess 238 and a second recess 239, and the first recess 238 and the second recess 239 are not substantially straight.

The shift device 200 is a shift device for a motor vehicle, and it comprises an operating mode element that is configured to shift among five operating modes (a park operating mode, a reverse operating mode, a neutral operating mode, a drive operating mode and a low operating mode)

The shift device 200 comprises a sensor housing 225 that comprises the housing face 201.

The shift device 200 comprises a first series of touch sensors 213 and a second series of touch sensors 214. The first series of touch sensors 213 consists of a first series first touch sensor 215, a first series second touch sensor 216, a first series third touch sensor 217, a first series fourth touch sensor 218, and a first series fifth touch sensor 219. The second series of touch sensors 214 consists of a second series first touch sensor 220, a second series second touch sensor 221, a second series third touch sensor 222, a second series fourth touch sensor 223, and a second series fifth touch sensor 224.

Each of the touch sensors comprises a respective sensor contact, i.e., the first series first touch sensor 215 comprises a first series first touch sensor contact 228, the first series second touch sensor 216 comprises a first series second touch sensor contact 229, the first series third touch sensor 217 comprises a first series third touch sensor contact 230, the first series fourth touch sensor 218 comprises a first series fourth touch sensor contact 231, the first series fifth touch sensor 219 comprises a first series fifth touch sensor contact 232, the second series first touch sensor 220 comprises a second series first touch sensor contact 233, the second series second touch sensor 221 comprises a second series second touch sensor contact 234, the second series third touch sensor 222 comprises a second series third touch sensor contact 235, the second series fourth touch sensor 223 comprises a second series fourth touch sensor contact 236, and the second series fifth touch sensor 224 comprises a second series fifth touch sensor contact 237.

The sensor contacts 228-232 of the first series of touch sensors 213 and the first recessed region 226 together define the first recess 238, and the sensor contacts 233-237 of the second series of touch sensors 214 and the second recessed region 227 together define the second recess 239.

The first recess 238 and the second recess 239 together form an hourglass shape, i.e., the first recess 238 comprises upper and lower wider regions and a narrower connecting region, in which the right edge of the upper and lower wider regions and the right edge of the narrower connecting region of the first recess 238 are substantially co-linear, and in which the left edge of the upper and lower wider regions and the left edge of the narrower connecting region of the second recess 239 are substantially co-linear.

Accordingly, each of the following features is satisfied:
a first portion of the first recess 238 is in a first region,
the first region is defined by first and second (imaginary) planes that (i) are perpendicular to the first direction, and (ii) are located such that the first touch sensor pair is in the first region and no other touch sensor pair is in the first region,
a second portion of the first recess 238 is in a second region,
the second region is defined by the second plane and a third (imaginary) plane,
the third plane (iii) is perpendicular to the first direction, and (iv) is located such that the second, third and fourth touch sensor pairs are in the second region and no other touch sensor pair is in the second region,
a contour of the first recess 238 in the first portion of the first recess 238 differs from a contour of the first recess 238 in the second portion of the first recess 238,
a plane of substantial symmetry of the first recess 238 in the first portion differs from a plane of substantial symmetry of the first recess 238 in the second portion,
a distance between (a) a fifth (imaginary) plane that is perpendicular to the second direction and that extends through each of the touch sensors in the first series and (b) a location in the first recess and in the first portion that is at least as far, in the second direction, from the fifth plane as any other location in the first recess and in the first portion,
   differs from a distance between (c) the fifth plane and (d) a location in the first recess and in the second portion that is at least as far, in the second direction, from the fifth plane as any other location in the first recess and in the second portion,
a maximum width, in the second direction, of the first portion of the first recess, is less than a maximum width, in the second direction, of the second portion of the first recess.

In the embodiment shown in FIG. 9, the portion of the first recess 238 in which the touch sensor contacts that correspond to reverse, neutral and drive are located (i.e., the second portion of the first recess 238) (1) is narrower than the portion of the first recess 238 (i.e., the first portion of the first recess 238) that the touch sensor contact that corresponds to park is located, and (2) is narrower than the portion of the first recess 238 that the touch sensor contact that corresponds to low is located.

Analogous features with respect to the second recess 239 are also satisfied (i.e., the features described above with regard to the first recess 238 are also true of the second recess 239).

The difference in the contour of the first recess 238 and the second recess 239 in the reverse, neutral and drive regions (relative to their contours in the park region and in the low region make it easier for an operator to recognize the respective identities of the touch sensors without looking at the shift device or with only a glance. This difference in contour in this embodiment makes it especially easy for a user to rapidly and repeatedly shift from reverse to drive and from drive back to reverse, e.g., when attempting to become unstuck, e.g., when stuck in snow or mud.

In an alternative embodiment, the shapes of the first and second recesses are analogous to their respective shapes in the embodiment depicted in FIG. 9, except that the first and second recesses are narrower in the park region and in the low region, and the first and second recesses are wider in the reverse, neutral and drive regions (i.e., a maximum width, in the second direction, of the first portion of the first recess, is greater than a maximum width, in the second direction, of the second portion of the first recess (and the same with respect to the second recess)).

In other alternative embodiments, the shift device is the same as the shift device depicted in FIG. 9 (or the alternative embodiment described in the preceding paragraph), except that one or more of the touch sensor contacts in the wider regions is/are moved farther from the center protrusion 242, thereby further facilitating an operator differentiating the park and the low touch sensors from the other touch sensors non-visually.

In the embodiment depicted in FIG. 9, the perimeters of the first recess 238 and of the second recess 239 (as well as other features, e.g., the outline of the entire shift device 200) are shown as being made up of substantially straight line segments. Any such regions can be of any other shape, as desired, e.g., any can be curved, slanted, wavy, zig-zag, etc. Analogously, any regions of the embodiment depicted in FIGS. 1-6, or any embodiments within the scope of the present inventive subject matter, can be of any desired shape.

The sensor housing 225 further comprises a protruding region 242 (i.e., protruding relative to the first recess 238 and the second recess 239) which is between the first series of touch sensors 213 and the second series of touch sensors 214 (likewise, between the first recess 238 and the second recess 239). The protruding region 242 comprises respective indicia between the respective touch sensors of each touch sensor pair, i.e., the letter P (representing “park” operating mode and “park” transmission mode) is between the first series first touch sensor 215 and the second series first touch sensor 220, the letter R (representing “reverse” operating mode and “reverse” transmission mode) is between the first series second touch sensor 216 and the second series second touch sensor 221, the letter N (representing “neutral” operating mode and “neutral” transmission mode) is between the first series third touch sensor 217 and the second series third touch sensor 222, the letter D (representing “drive” operating mode and “drive” transmission mode) is between the first series fourth touch sensor 218 and the second series fourth touch sensor 223, and the letter L (representing “low” operating mode and “low” transmission mode) is between the first series fifth touch sensor 219 and the second series fifth touch sensor 224. In this embodiment, the respective indicia (“P”, “R”, “N”, “D” and “L”) are made of light emitting diodes (LEDs) that emit white light at all time that the vehicle is running, except that the indicia that corresponds to the operating mode in which the shift device currently is operating emit red light.

Each of the five touch sensor pairs corresponds to a respective one of the five respective operating modes of the motor vehicle (the five operating modes corresponding to the respective five transmission modes). The first touch sensor pair corresponds to the “park” operating mode. The second touch sensor pair corresponds to the “reverse” operating mode. The third touch sensor pair corresponds to the “neutral” operating mode. The fourth touch sensor pair corresponds to the “drive” operating mode. The fifth touch sensor pair corresponds to the “low” operating mode.

Accordingly, each of the letters “P”, “R”, “N”, “D” and “L” on the center region is located between the respective touch sensor pair that corresponds to the operating mode that the letter represents (i.e., “P” represents “park”, and “P” is between the two touch sensor pairs that correspond to the park operating mode, “N” represents “neutral”, and “N” is between the two touch sensor pairs that correspond to the neutral operating mode, etc.).

1. A shift device, comprising:
at least first and second series of touch sensors; and
an operating mode element,
the first series comprising at least three touch sensors, the touch sensors in the first series arranged in a first pattern that extends in a first direction,
the second series comprising at least three touch sensors, the touch sensors in the second series arranged in a second pattern that extends in the first direction, the second pattern extending substantially parallel to the first pattern,
the first pattern and the second pattern aligned to provide a plurality of touch sensor pairs,
each touch sensor pair comprising a touch sensor of the first series and a touch sensor of the second series,
for each touch sensor pair, the touch sensor of the first series and the touch sensor of the second series are aligned in a second direction, the second direction substantially perpendicular to the first direction,
each touch sensor pair corresponding to a respective one of a plurality of operating modes, and
the operating mode element configured to change from one of the plurality of operating modes to a different one of the plurality of operating modes, and to emit a shift signal indicating the operating mode to which the operating mode element has changed, only upon occurrence of a sequence of actions consisting of:
a shift initiation action consisting of each touch sensor in a shift initiation touch sensor pair simultaneously sensing a touch, said shift initiation touch sensor pair being one of said plurality of touch sensor pairs and corresponding to a current operating mode, said current operating mode being one of said operating modes and being an operating mode in which the operating mode element is at the time of the shift initiation action, and then
at least a first operating mode change action, each said operating mode change action consisting of:
each touch sensor in a shift-to sensor pair simultaneously sensing a touch within a maximum duration time interval since said shift initiation action or a most recent previous operating mode change action,
said shift-to sensor pair being one of said plurality of touch sensor pairs and being adjacent to a current mode touch sensor pair,
said current mode touch sensor pair being one of said plurality of touch sensor pairs and corresponding to an operating mode in which the operating mode element is at the time of the operating mode change action.

2. A shift device as recited in claim 1, wherein:
the device further comprises a sensor housing,
the sensor housing comprises at least a first recessed region and a second recessed region,
each of the touch sensors comprises a respective touch sensor contact,
the touch sensor contacts of the first series of touch sensors and the first recessed region together define a first recess, and
the touch sensor contacts of the second series of touch sensors and the second recessed region together define a second recess.

3. A shift device as recited in claim 2, wherein:
an axis of the first recess is substantially parallel to the first direction, and
an axis of the second recess is substantially parallel to the first direction.

4. A shift device as recited in claim 2, wherein
the plurality of touch sensor pairs comprises at least a first touch sensor pair, a second touch sensor pair that is adjacent to the first touch sensor pair, a third touch sensor pair that is adjacent to the second touch sensor pair, and a fourth touch sensor pair that is adjacent to the third touch sensor pair,
a first portion of the first recess is in a first region,
the first region is defined by first and second planes that (i) are perpendicular to the first direction, and (ii) are located such that the first touch sensor pair is in the first region and no other touch sensor pair is in the first region,
a second portion of the first recess is in a second region,
the second region is defined by the second plane and a third plane,
the third plane (iii) is perpendicular to the first direction, and (iv) is located such that the second, third and fourth touch sensor pairs are in the second region and no other touch sensor pair is in the second region, and
a contour of the first recess in the first portion differs from a contour of the first recess in the second portion.

5. A shift device as recited in claim 2, wherein
the plurality of touch sensor pairs comprises at least a first touch sensor pair, a second touch sensor pair that is adjacent to the first touch sensor pair, a third touch sensor pair that is adjacent to the second touch sensor pair, and a fourth touch sensor pair that is adjacent to the third touch sensor pair,
a first portion of the first recess is in a first region,
the first region is defined by first and second planes that (i) are perpendicular to the first direction, and (ii) are located such that the first touch sensor pair is in the first region and no other touch sensor pair is in the first region,
a second portion of the first recess is in a second region,
the second region is defined by the second plane and a third plane,
the third plane (iii) is perpendicular to the first direction, and (iv) is located such that the second, third and fourth touch sensor pairs are in the second region and no other touch sensor pair is in the second region, and
a plane of substantial symmetry of the first recess in the first portion differs from a plane of substantial symmetry of the first recess in the second portion.

6. A shift device as recited in claim 2, wherein
the plurality of touch sensor pairs comprises at least a first touch sensor pair, a second touch sensor pair that is adjacent to the first touch sensor pair, a third touch sensor pair that is adjacent to the second touch sensor pair, and a fourth touch sensor pair that is adjacent to the third touch sensor pair,
a first portion of the first recess is in a first region,
the first region is defined by first and second planes that (i) are perpendicular to the first direction, and (ii) are located such that the first touch sensor pair is in the first region and no other touch sensor pair is in the first region,
a second portion of the first recess is in a second region,
the second region is defined by the second plane and a third plane,
the third plane (iii) is perpendicular to the first direction, and (iv) is located such that the second, third and fourth touch sensor pairs are in the second region and no other touch sensor pair is in the second region, and
a distance between (a) a first plane that is perpendicular to the second direction and that extends through each of the touch sensors in the first series and (b) a location in the first recess and in the first portion that is at least as far, in the second direction, from the first plane as any other location in the first recess and in the first portion,
differs from:
a distance between (c) the first plane and (d) a location in the first recess and in the second portion that is at least as far, in the second direction, from the first plane as any other location in the first recess and in the second portion.

7. A shift device as recited in claim 2, wherein
the plurality of touch sensor pairs comprises at least a first touch sensor pair, a second touch sensor pair that is adjacent to the first touch sensor pair, a third touch sensor pair that is adjacent to the second touch sensor pair, and a fourth touch sensor pair that is adjacent to the third touch sensor pair,
a first portion of the first recess is in a first region,
the first region is defined by first and second planes that (i) are perpendicular to the first direction, and (ii) are located such that the first touch sensor pair is in the first region and no other touch sensor pair is in the first region,
a second portion of the first recess is in a second region,
the second region is defined by the second plane and a third plane,
the third plane (iii) is perpendicular to the first direction, and (iv) is located such that the second, third and fourth touch sensor pairs are in the second region and no other touch sensor pair is in the second region, and
a maximum width, in the second direction, of the first portion of the first recess,
is less than:
a maximum width, in the second direction, of the second portion of the first recess.

8. A shift device as recited in claim 7, wherein
the plurality of operating modes comprises a park mode, a reverse mode, a neutral mode and a drive mode for a motor vehicle,
the first touch sensor pair corresponds to said park mode,
the second touch sensor pair corresponds to said reverse mode,
the third touch sensor pair corresponds to said neutral mode, and
the fourth touch sensor pair corresponds to said drive mode.

9. A shift device as recited in claim 2, wherein
the plurality of touch sensor pairs comprises at least a first touch sensor pair, a second touch sensor pair that is adjacent to the first touch sensor pair, a third touch sensor pair that is adjacent to the second touch sensor pair, and a fourth touch sensor pair that is adjacent to the third touch sensor pair,
a first portion of the first recess is in a first region,
the first region is defined by first and second planes that (i) are perpendicular to the first direction, and (ii) are located such that the first touch sensor pair is in the first region and no other touch sensor pair is in the first region,
a second portion of the first recess is in a second region,
the second region is defined by the second plane and a third plane,
the third plane (iii) is perpendicular to the first direction, and (iv) is located such that the second, third and fourth touch sensor pairs are in the second region and no other touch sensor pair is in the second region, and
a maximum width, in the second direction, of the first portion of the first recess,
is greater than:
a maximum width, in the second direction, of the second portion of the first recess.

10. A shift device as recited in claim 9, wherein
the plurality of operating modes comprises a park mode, a reverse mode, a neutral mode and a drive mode for a motor vehicle,
the first touch sensor pair corresponds to said park mode,
the second touch sensor pair corresponds to said reverse mode,
the third touch sensor pair corresponds to said neutral mode, and
the fourth touch sensor pair corresponds to said drive mode.

11. A shift device as recited in claim 1, wherein the device further comprises a protruding region, the protruding region between the first series and the second series.

12. A shift device as recited in claim 11, wherein the protruding region comprises respective indicia between the respective touch sensors of each touch sensor pair.

13. A shift device as recited in claim 11, wherein the protruding region extends at least substantially along the entire distance of a region between the first series and the second series, such that any plane that passes through any portion of the first series and any portion of the second series also passes through the protruding region.

14. A shift device as recited in claim 1, wherein the first series of touch sensors and the second series of touch sensors together comprise all of the touch sensors in the device.

15. A shift device as recited in claim 1, wherein the plurality of operating modes correspond to transmission modes of a motor vehicle.

16. A shift device as recited in claim 1, wherein
the plurality of touch sensor pairs comprises at least a first touch sensor pair, a second touch sensor pair that is adjacent to the first touch sensor pair, a third touch sensor pair that is adjacent to the second touch sensor pair, and a fourth touch sensor pair that is adjacent to the third touch sensor pair
the plurality of operating modes comprises a park mode, a reverse mode, a neutral mode and a drive mode for a motor vehicle,
the first touch sensor pair corresponds to said park mode,
the second touch sensor pair corresponds to said reverse mode,
the third touch sensor pair corresponds to said neutral mode, and
the fourth touch sensor pair corresponds to said drive mode.

17. A shift device as recited in claim 1, wherein:
the plurality of touch sensor pairs comprises at least a first touch sensor pair, a second touch sensor pair that is adjacent to the first touch sensor pair, a third touch sensor pair that is adjacent to the second touch sensor pair, and a fourth touch sensor pair that is adjacent to the third touch sensor pair,
the first touch sensor pair comprises a first series first touch sensor and a second series first touch sensor,
the second touch sensor pair comprises a first series second touch sensor and a second series second touch sensor,
the third touch sensor pair comprises a first series third touch sensor and a second series third touch sensor,
the first touch sensor pair comprises a first series fourth touch sensor and a second series fourth touch sensor,
the device further comprises:
a first surface irregularity between the first series first touch sensor and the first series second touch sensor,
a second surface irregularity between the first series second touch sensor and the first series third touch sensor,
a third surface irregularity between the first series third touch sensor and the first series fourth touch sensor,
a fourth surface irregularity between the second series first touch sensor and the second series second touch sensor,
a fifth surface irregularity between the second series second touch sensor and the second series third touch sensor, and
a sixth surface irregularity between the second series third touch sensor and the second series fourth touch sensor.

18. A shift device as recited in claim 17, wherein each of the first, second, third, fourth, fifth and sixth surface irregularities is a raised portion or a recessed portion.

19. A shift device as recited in claim 1, wherein:
the device further comprises one or more vibration elements,
the device is configured to cause at least one of the one or more vibration elements to vibrate upon occurrence of a sequence of actions consisting of a shift initiation action and then at least a first operating mode change action.

20. A shift device as recited in claim 19, wherein:
said vibration of the at least one of the one or more vibration elements can be felt at said pair of touch sensors adjacent to the pair of touch sensors that were touched in the initiation sensor-pair activation.

21. A shift device as recited in claim 1, wherein
the device further comprises one or more sound emission elements,
the device is configured to cause at least one of the one or more sound emission elements to emit sound upon occurrence of a sequence of actions consisting of a shift initiation action and then at least a first operating mode change action.

22. An article of equipment comprising:
a shift device as recited in claim 1, and
a system that has a plurality of system modes, each system mode corresponding to one of the operating modes of the shift device,
wherein upon receiving a shift signal from the operating mode element, the system changes to a system mode that corresponds to the operating mode indicated in the shift signal.

23. A shift device, comprising:
first and second series of touch sensors;
an operating mode element; and
a sensor housing,
the first series comprising at least a first series first touch sensor, a first series second touch sensor, a first series third touch sensor and a first series fourth touch sensor, the touch sensors in the first series arranged in a first pattern that extends in a first direction,
the second series comprising at least a second series first touch sensor, a second series second touch sensor, a second series third touch sensor and a second series fourth touch sensor, the touch sensors in the second series arranged in a second pattern that extends in the first direction, the second pattern extending substantially parallel to the first pattern,
the first pattern and the second pattern aligned to provide a plurality of touch sensor pairs,
each touch sensor pair comprising a touch sensor of the first series and a touch sensor of the second series,
the plurality of touch sensor pairs comprises at least a first touch sensor pair, a second touch sensor pair that is adjacent to the first touch sensor pair, a third touch sensor pair that is adjacent to the second touch sensor pair, and a fourth touch sensor pair that is adjacent to the third touch sensor pair,
the first touch sensor pair comprises the first series first touch sensor and the second series first touch sensor,
the second touch sensor pair comprises the first series second touch sensor and the second series second touch sensor,
the third touch sensor pair comprises the first series third touch sensor and the second series third touch sensor,
the first touch sensor pair comprises the first series fourth touch sensor and the second series fourth touch sensor,
for each touch sensor pair, the touch sensor of the first series and the touch sensor of the second series are aligned in a second direction, the second direction substantially perpendicular to the first direction,
each touch sensor pair corresponding to a respective one of a plurality of operating modes of a motor vehicle, said operating modes comprising a park mode, a reverse mode, a neutral mode and a drive mode,
the first touch sensor pair corresponding to said park mode,
the second touch sensor pair corresponding to said reverse mode,
the third touch sensor pair corresponding to said neutral mode, and
the fourth touch sensor pair corresponding to said drive mode,
the operating mode element configured to change from one of the plurality of operating modes to a different one of the plurality of operating modes, and to emit a shift signal indicating the operating mode to which the operating mode element has changed, only upon occurrence of a sequence of actions consisting of:
a shift initiation action consisting of each touch sensor in a shift initiation touch sensor pair simultaneously sensing a touch, said shift initiation touch sensor pair being one of said plurality of touch sensor pairs and corresponding to a current operating mode, said current operating mode being one of said operating modes and being an operating mode in which the operating mode element is at the time of the shift initiation action, and then
at least a first operating mode change action, each said operating mode change action consisting of:
each touch sensor in a shift-to sensor pair simultaneously sensing a touch within a maximum duration time interval since said shift initiation action or a most recent previous operating mode change action,
said shift-to sensor pair being one of said plurality of touch sensor pairs and being adjacent to a current mode touch sensor pair,
said current mode touch sensor pair being one of said plurality of touch sensor pairs and corresponding to an operating mode in which the operating mode element is at the time of the operating mode change action,
the sensor housing comprising at least a first recessed region and a second recessed region,
each of the touch sensors comprising a respective touch sensor contact,
the touch sensor contacts of the first series of touch sensors and the first recessed region together defining a first recess, and
the touch sensor contacts of the second series of touch sensors and the second recessed region together defining a second recess.

24. A shift device as recited in claim 23, wherein:
an axis of the first recess is substantially parallel to the first direction, and
an axis of the second recess is substantially parallel to the first direction.

25. A shift device as recited in claim 23, wherein
a first portion of the first recess is in a first region,
the first region is defined by first and second planes that (i) are perpendicular to the first direction, and (ii) are located such that the first touch sensor pair is in the first region and no other touch sensor pair is in the first region,
a second portion of the first recess is in a second region,
the second region is defined by the second plane and a third plane,
the third plane (iii) is perpendicular to the first direction, and (iv) is located such that the second, third and fourth touch sensor pairs are in the second region and no other touch sensor pair is in the second region, and
a contour of the first recess in the first portion differs from a contour of the first recess in the second portion.

26. A shift device as recited in claim 23, wherein
a first portion of the first recess is in a first region,
the first region is defined by first and second planes that (i) are perpendicular to the first direction, and (ii) are located such that the first touch sensor pair is in the first region and no other touch sensor pair is in the first region,
a second portion of the first recess is in a second region,
the second region is defined by the second plane and a third plane,
the third plane (iii) is perpendicular to the first direction, and (iv) is located such that the second, third and fourth touch sensor pairs are in the second region and no other touch sensor pair is in the second region, and
a plane of substantial symmetry of the first recess in the first portion differs from a plane of substantial symmetry of the first recess in the second portion.

27. A shift device as recited in claim 23, wherein
a first portion of the first recess is in a first region,
the first region is defined by first and second planes that (i) are perpendicular to the first direction, and (ii) are located such that the first touch sensor pair is in the first region and no other touch sensor pair is in the first region,
a second portion of the first recess is in a second region,
the second region is defined by the second plane and a third plane,
the third plane (iii) is perpendicular to the first direction, and (iv) is located such that the second, third and fourth touch sensor pairs are in the second region and no other touch sensor pair is in the second region, and
a distance between (a) a first plane that is perpendicular to the second direction and that extends through each of the touch sensors in the first series and (b) a location in the first recess and in the first portion that is at least as far, in the second direction, from the first plane as any other location in the first recess and in the first portion,
differs from:
a distance between (c) the first plane and (d) a location in the first recess and in the second portion that is at least as far, in the second direction, from the first plane as any other location in the first recess and in the second portion.

28. A shift device as recited in claim 23, wherein
a first portion of the first recess is in a first region,
the first region is defined by first and second planes that (i) are perpendicular to the first direction, and (ii) are located such that the first touch sensor pair is in the first region and no other touch sensor pair is in the first region,
a second portion of the first recess is in a second region,
the second region is defined by the second plane and a third plane,
the third plane (iii) is perpendicular to the first direction, and (iv) is located such that the second, third and fourth touch sensor pairs are in the second region and no other touch sensor pair is in the second region, and
a maximum width, in the second direction, of the first portion of the first recess,
is less than:
a maximum width, in the second direction, of the second portion of the first recess.

29. A shift device as recited in claim 23, wherein the device further comprises:
a first surface irregularity between the first series first touch sensor and the first series second touch sensor,
a second surface irregularity between the first series second touch sensor and the first series third touch sensor,
a third surface irregularity between the first series third touch sensor and the first series fourth touch sensor,
a fourth surface irregularity between the second series first touch sensor and the second series second touch sensor,
a fifth surface irregularity between the second series second touch sensor and the second series third touch sensor, and
a sixth surface irregularity between the second series third touch sensor and the second series fourth touch sensor.

30. A shift device as recited in claim 29, wherein each of the first, second, third, fourth, fifth and sixth surface irregularities is a raised portion or a recessed portion.

31. A shift device as recited in claim 23, wherein:
the device further comprises one or more vibration elements,
the device is configured to cause at least one of the one or more vibration elements to vibrate upon occurrence of a sequence of actions consisting of a shift initiation action and then at least a first operating mode change action.

32. A shift device as recited in claim 31, wherein:
said vibration of the at least one of the one or more vibration elements can be felt at said pair of touch sensors adjacent to the pair of touch sensors that were touched in the initiation sensor-pair activation.

33. A shift device as recited in claim 23, wherein
the device further comprises one or more sound emission elements,
the device is configured to cause at least one of the one or more sound emission elements to emit sound upon occurrence of a sequence of actions consisting of a shift initiation action and then at least a first operating mode change action.

34. An article of equipment comprising:
a shift device as recited in claim 23, and
a system that has a plurality of system modes, each system mode corresponding to one of the operating modes of the shift device,
wherein upon receiving a shift signal from the operating mode element, the system changes to a system mode that corresponds to the operating mode indicated in the shift signal.

35. A shift device, comprising:
at least first and second series of touch sensors; and
an operating mode element,
the first series comprising at least three touch sensors, the touch sensors in the first series arranged in a first pattern that extends in a first direction,
the second series comprising at least three touch sensors, the touch sensors in the second series arranged in a second pattern that extends in the first direction, the second pattern extending substantially parallel to the first pattern,
the first pattern and the second pattern aligned to provide a plurality of touch sensor pairs,
each touch sensor pair comprising a touch sensor of the first series and a touch sensor of the second series,
for each touch sensor pair, the touch sensor of the first series and the touch sensor of the second series are aligned in a second direction, the second direction substantially perpendicular to the first direction,
each touch sensor pair corresponding to a respective one of a plurality of operating modes, and
the operating mode element configured to change from one of the plurality of operating modes to a different one of the plurality of operating modes, and to emit a shift signal indicating the operating mode to which the operating mode element has changed, only upon occurrence of a sequence of actions consisting of:
a shift initiation action consisting of each touch sensor in a shift initiation touch sensor pair simultaneously sensing a touch, said shift initiation touch sensor pair being one of said plurality of touch sensor pairs and corresponding to a current operating mode, said current operating mode being one of said operating modes and being an operating mode in which the operating mode element is at the time of the shift initiation action, and then
at least a first operating mode change action, each said operating mode change action consisting of:
each touch sensor in a shift-to sensor pair simultaneously sensing a touch within a maximum duration time interval since said shift initiation action or a most recent previous operating mode change action,
said shift-to sensor pair being one of said plurality of touch sensor pairs and being different from a current mode touch sensor pair,
said current mode touch sensor pair being one of said plurality of touch sensor pairs and corresponding to an operating mode in which the operating mode element is at the time of the operating mode change action.

36. An article of equipment comprising:
a shift device as recited in claim 35, and
a system that has a plurality of system modes, each system mode corresponding to one of the operating modes of the shift device,
wherein upon receiving a shift signal from the operating mode element, the system changes to a system mode that corresponds to the operating mode indicated in the shift signal.

37. A method of shifting, comprising:
performing a shift initiation action comprising simultaneously touching both touch sensors in a first touch sensor pair corresponding to a first operating mode, the first touch sensor pair being among a plurality of touch sensor pairs in a device for issuing shift commands upon receiving valid shift sequences, said first operating mode being selected from among a plurality of operating modes, said current operating mode being an operating mode in which said device is currently operating,
and then, within a maximum duration time interval since said simultaneously touching both touch sensors in the first touch sensor pair, performing a first operating mode change action, said first operating mode change action comprising simultaneously touching both touch sensors in a second touch sensor pair corresponding to a second operating mode, the second touch sensor pair being among the plurality of touch sensor pairs, the second operating mode being among the plurality of operating modes,
each of said plurality of touch sensor pairs comprising one of a first series of touch sensors and one of a second series of touch sensors, the first series comprising at least three touch sensors arranged in a first pattern that extends in a first direction, the second series comprising at least three touch sensors arranged in a second pattern that extends in the first direction, the second pattern extending substantially parallel to the first pattern,
the first pattern and the second pattern aligned to provide said plurality of touch sensor pairs,
each touch sensor pair comprising a touch sensor of the first series and a touch sensor of the second series,
for each touch sensor pair, the touch sensor of the first series and the touch sensor of the second series are aligned in a second direction, the second direction substantially perpendicular to the first direction,
each touch sensor pair corresponding to a respective one of said plurality of operating modes.

38. A method as recited in claim 37, wherein:
said device for issuing shift commands comprises an operating mode element, and
upon said performing a shift initiation action and said performing said first operating mode change action, the operating mode element changes from the first operating mode to the second operating mode, and the operating mode element emits a shift signal indicating the operating mode to which the operating mode element has changed.

39. A method as recited in claim 37, wherein the second touch sensor pair being adjacent to the first touch sensor pair.

40. A method as recited in claim 39, wherein:
the method comprises performing at least one additional operating mode change action,
each additional operating mode change comprising:
simultaneously touching both touch sensors in a shift-to touch sensor pair within a maximum duration time interval since a most recent previous operating mode change action,
said shift-to sensor pair being one of said plurality of touch sensor pairs and being adjacent to a current mode touch sensor pair,
said current mode touch sensor pair being one of said plurality of touch sensor pairs and corresponding to an operating mode in which the operating mode element is at the time of the additional operating mode change action.

41. A method as recited in claim 37, wherein:
the method comprises performing at least one additional operating mode change action,
each additional operating mode change comprising simultaneously touching both touch sensors in one of said plurality of touch sensor pairs within a maximum duration time interval since both touch sensors in another of said plurality of touch sensor pairs were simultaneously touched.
